(19) United States
(12) Patent Application Publication
(10) Pub. No.: US 2016/0070777 A1
(43) Pub. Date: Mar. 10, 2016

(54) SYSTEM AND METHOD FOR CONTENT COLLECTION, CATALOGING, AND COLLABORATION

(71) Applicant: VISUAL MOBILE TECHNOLOGIES, INC., Auburn, CA (US)

(72) Inventors: Raymond Lubeck, Sacramento, CA (US); Kelvin Hubbard, Sacramento, CA (US)

(21) Appl. No.: 14/827,126

(22) Filed: Aug. 14, 2015

Related U.S. Application Data
(60) Provisional application No. 62/046,043, filed on Sep. 4, 2014.

(51) Int. Cl. G06F 17/30

(52) U.S. Cl. CPC G06F 17/30598

(57) ABSTRACT

Mobile and Web applications for the collection of digital media (photos, video, audio, documents, etc.), cataloging (using metadata in the form of tags), and collaborating (using storage and collaboration software). The applications allow an individual to collect digital content by using the native capabilities on their mobile device, or by uploading content already captured (in storage) and associating it with Events and Sessions. Additionally, individuals may capture or upload digital media without associating it with either Events or Sessions at the time of capture or upload, to later make these associations. Events, Sessions, and digital media are automatically (by the application) tagged with date, time, user, and location, while also allowing other stored and/or newly created tags to be added at the time of capture or upload, or later, as desired. Other individuals may be given permission to view or modify Events and/or Sessions, and to view digital media by the owner or contributor of the Event or Session. While accessing a Session, other individuals may be invited to participate in a live collaboration and view all content, as well as participate/contribute via their computer or a mobile device, and participate in a one-to-many video conference. All content is stored in the cloud, and audited through the use of Activity logs which capture all adds/changes/deletes to the database.

### PRIORITY PATENT APPLICATION

The present application is non-provisional patent application drawing priority from co-pending U.S. provisional patent application Ser. No. 62/046,043; filed Sep. 4, 2014. This present patent application draws priority from the referenced patent application. The entire disclosure of the referenced patent application is considered part of the disclosure of the present application and is hereby incorporated by reference herein in its entirety.

### TECHNICAL FIELD

This patent application relates to computer-implemented software and networked systems, according to one embodiment, and more specifically to a system and method for content collection, cataloging, and collaboration.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2013-2015 Visual Mobile Technologies Inc., All Rights Reserved.

### BACKGROUND

As mobile devices increase in power and functionality, these devices become increasingly important as sources of content in addition to being consumers of content. One important source of content on these devices is the image or video capture components provided with camera-enabled mobile devices. There are a variety of systems and methods available for capturing images on a mobile device and uploading the images to the network cloud. In many cases, these systems enable the capture and retention of photo libraries. In other cases, these systems support security or access control applications. In still other cases, these systems support social networking applications.

For example, U.S. Pat. No. 7,639,943 describes a computer-implemented system and method for automatically capturing a set of images with a camera-enabled mobile device and for uploading the set of images to a network server. The system further includes creating an animation of two or more images of the set of images automatically captured by the camera-enabled mobile device.

U.S. Pat. No. 8,418,231 describes a system wherein media content is managed by defining a list of authorized recipients in a network accessible security information repository, recording media content at a client device, obtaining the list of authorized recipients at the client device, associating at least one of the authorized recipients with the media content, and transmitting the media content along with information identifying at least one of the authorized recipients associated therewith from the client device to a network accessible media repository for storage therein. The media content includes audio, video, and/or image content.

U.S. Pat. No. 8,385,950 describes a computer-implemented method for automatically uploading media content from a mobile device to an online service provider for receiving, in the mobile device, identifying information corresponding to a user account associated with at least one of a plurality of online service providers; capturing media content with a media input component included in the mobile device; and after the media content is captured, automatically uploading to at least one online service provider the captured media content and the identifying information, without receiving user input contemporaneous with the automatic uploading that specifies that the captured media content is to be uploaded. The mobile device can further include a wireless communication component configured to wirelessly send data to and wirelessly receive data from the plurality of online service providers, which can be external to the mobile device.

U.S. Pat. No. 8,665,337 describes an image processing apparatus that determines categories for classifying image data based on shooting information of the image data, generates an update information file for each category, and uploads the update information file along with the image data to an image managing server.

Other content sharing systems, such as Vimeo™, Scoop™, and FotoNotes™ are also well-known. Vimeo is a U.S.-based video-sharing website on which users can upload, share and view videos. FotoNotes is a mobile solution for real estate field services, including property and facilities management, property preservation, broker price opinions, and construction estimates. It's a tool to collect and share real estate information, including photos, voice notes, text, and other information in the field.

However, in spite of an increasing number of systems that have been made available to both the enterprise and consumer markets, no publicly available system has been created that delivers a comprehensive solution that allows groups of individuals to collect content, catalog that content, and share it with both internal and external individuals in a safe, secure, cost-effective, and easily-used (across multiple platforms) manner.

### BRIEF DESCRIPTION OF THE DRAWINGS

The various embodiments are illustrated by way of example, and not by way of limitation, in the figures of the accompanying drawings in which:

FIG. 1 illustrates an example embodiment of the general flow of how one might use the web application, and the modules that one might use while accessing the application during a typical use case;

FIG. 2 illustrates an example embodiment of the general flow of how one might use the mobile application, and the modules that one might use while accessing the application during a typical use case;

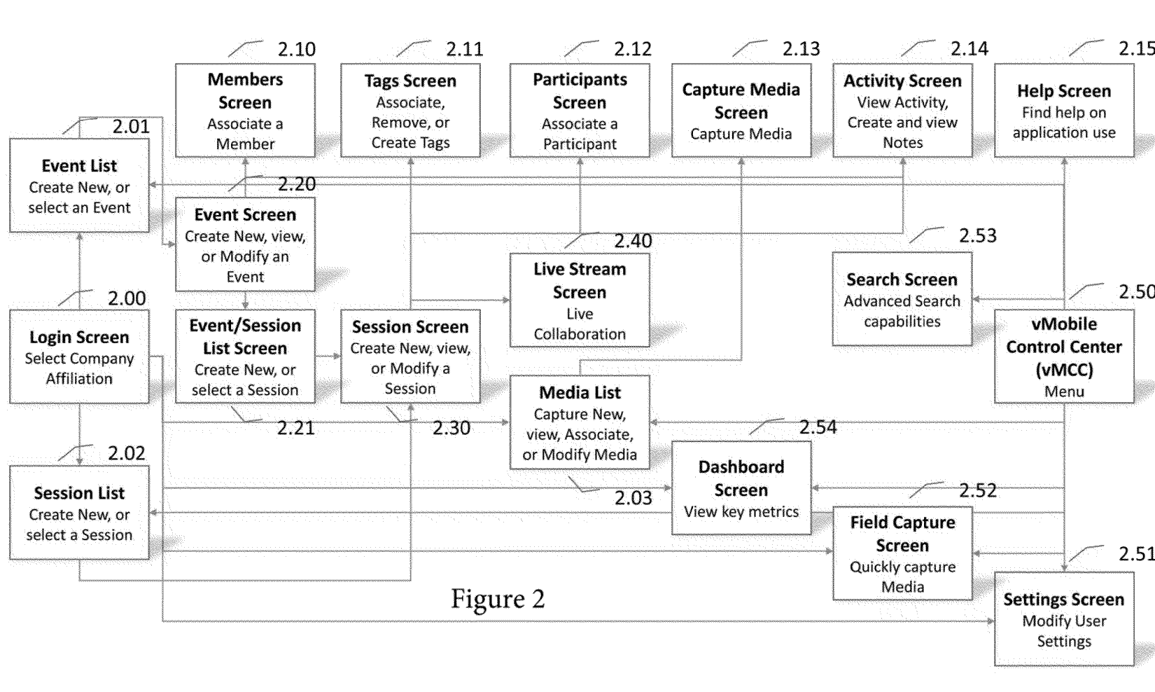

FIG. 3 illustrates an example embodiment of the overall architecture of the vMobile Collaborator system of an example embodiment, and the individual layers of the system;

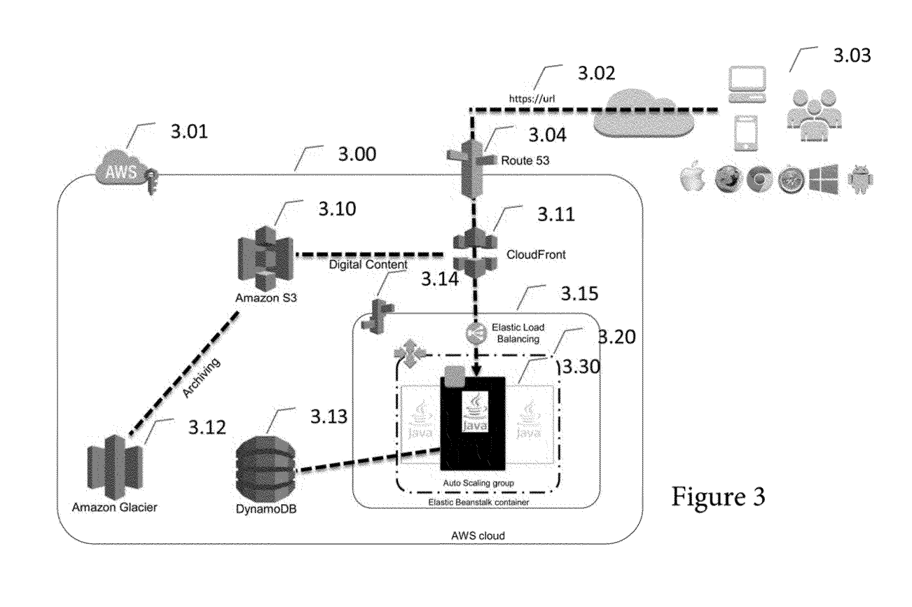

FIG. 4 illustrates an example embodiment of the hierarchical layout of how a company might use the application to manage and organize content, which shows the relationships between Events, Sessions, and Media, as well as the use of a Live Stream collaboration that may happen from a Session with (in this case) three Participants;

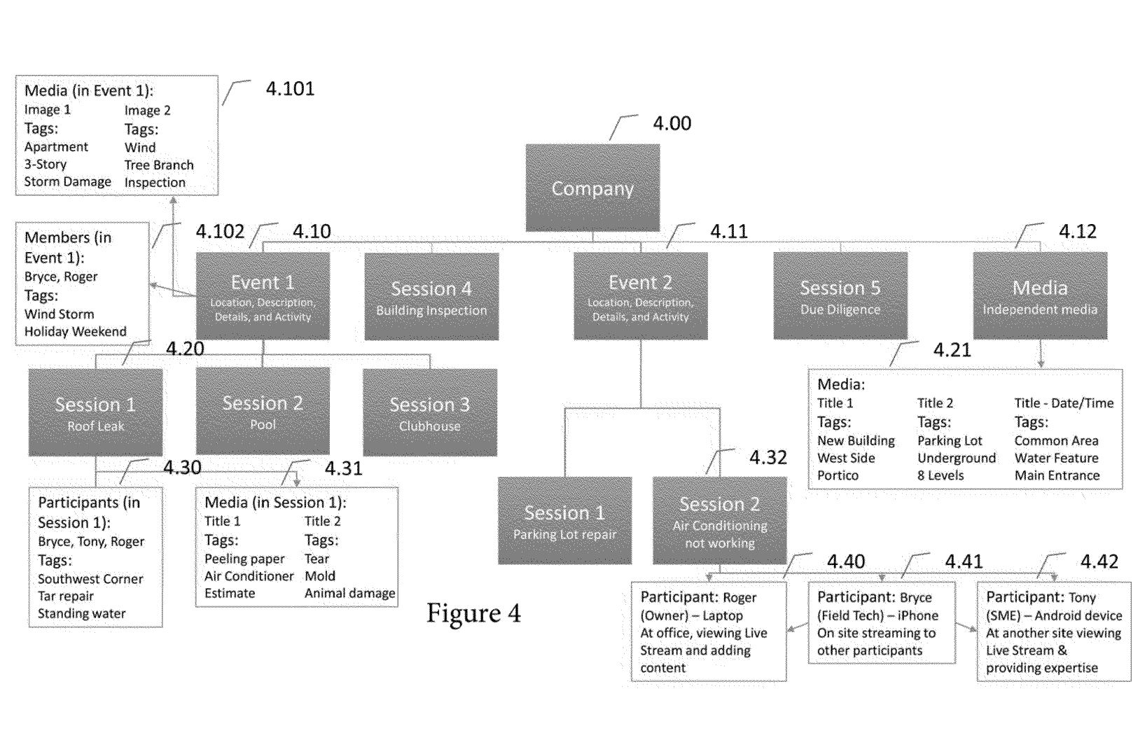

FIG. 5 illustrates an example embodiment of the process flow and options available in both the mobile and web applications for how a user might work within the application as it pertains to working with Events;

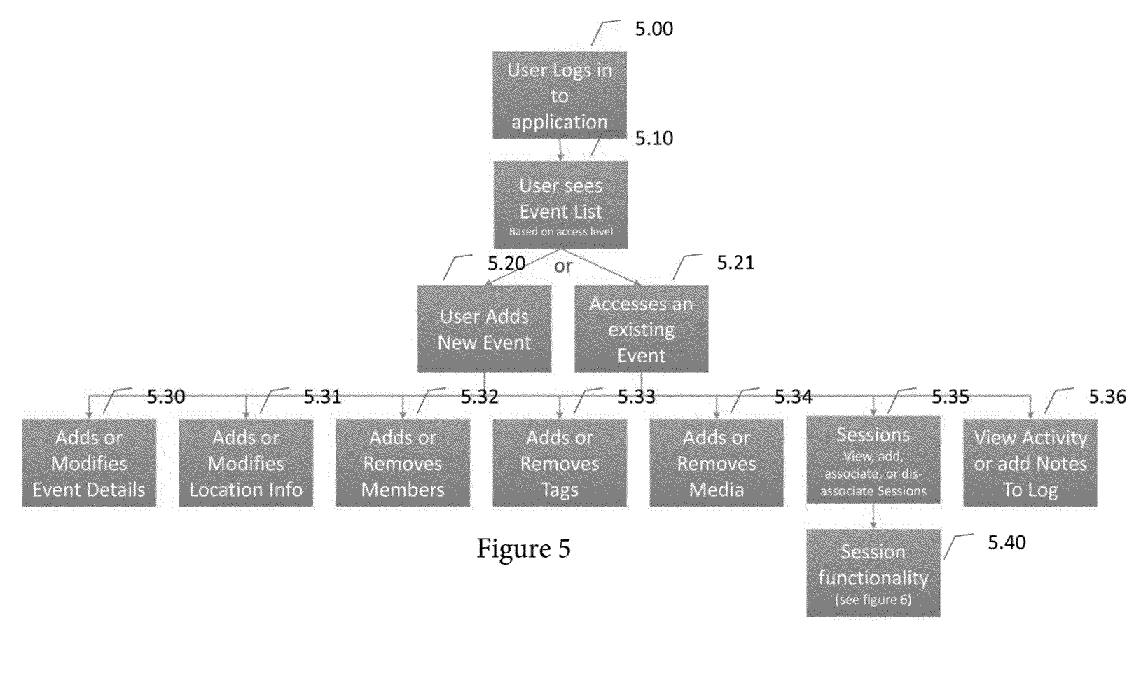

FIG. 6 illustrates an example embodiment of the process flow and options available in both the mobile and web applications for how a user might work within the application as it pertains to working with Sessions;

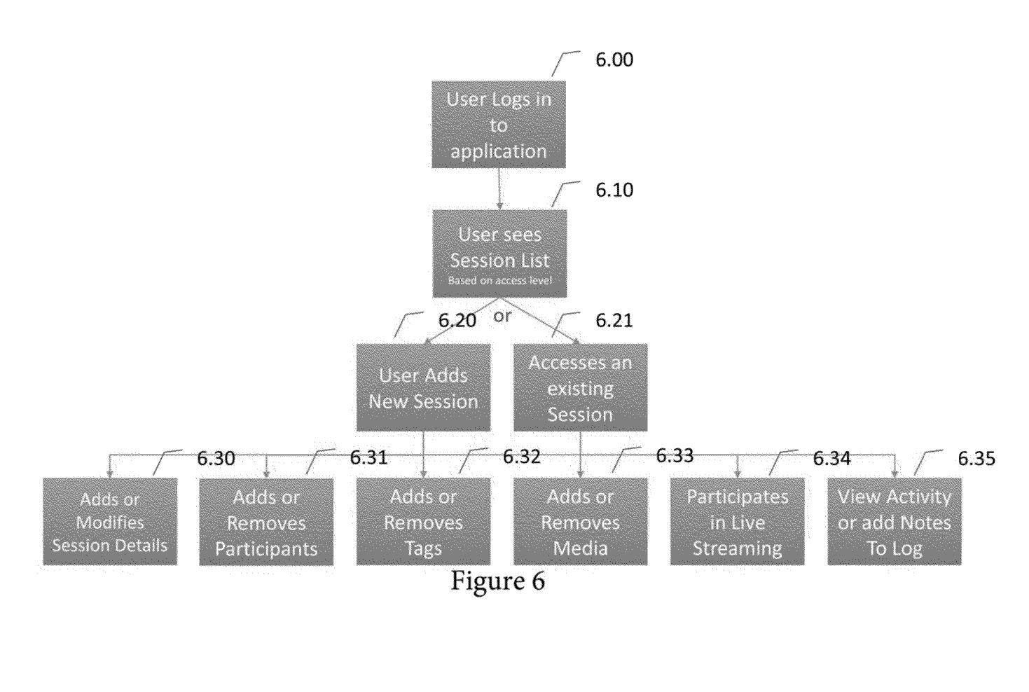

FIG. 7 illustrates an example embodiment of the process and data flows and options available in both the mobile and web applications for how a user might work within the application as it pertains to working with Events;

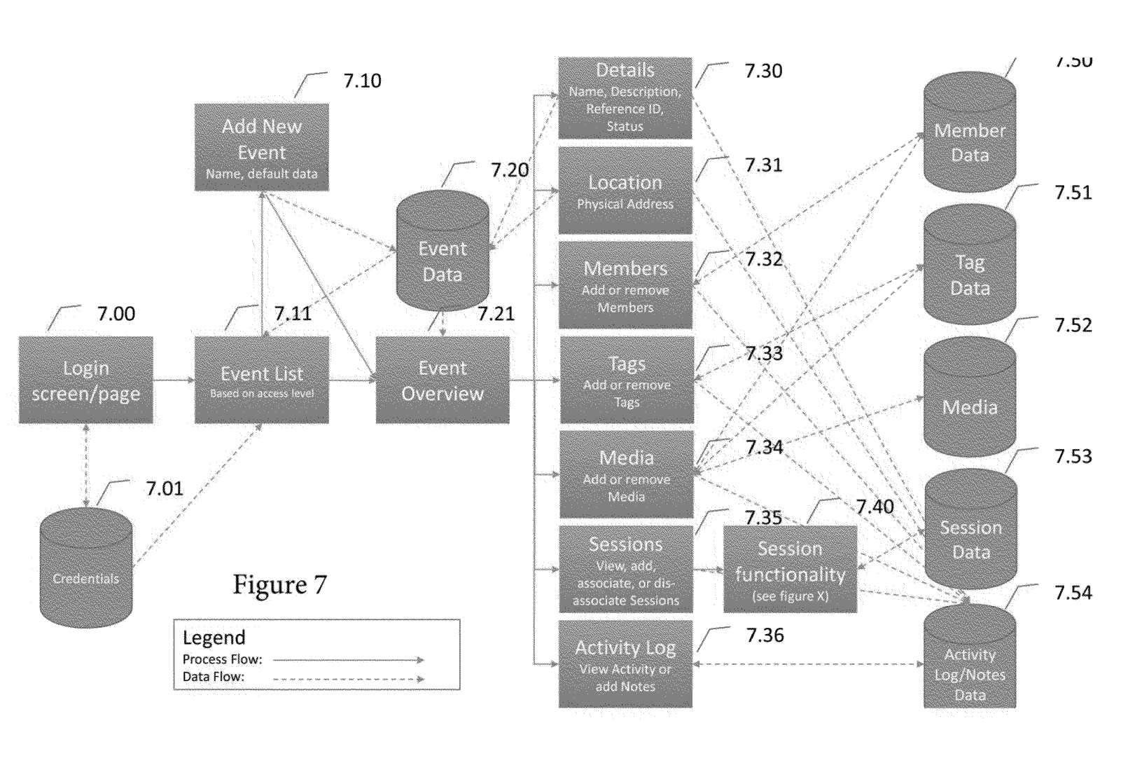

FIG. 8 illustrates an example embodiment of the process and data flows and options available in both the mobile and web applications for how a user might work within the application as it pertains to working with Sessions;

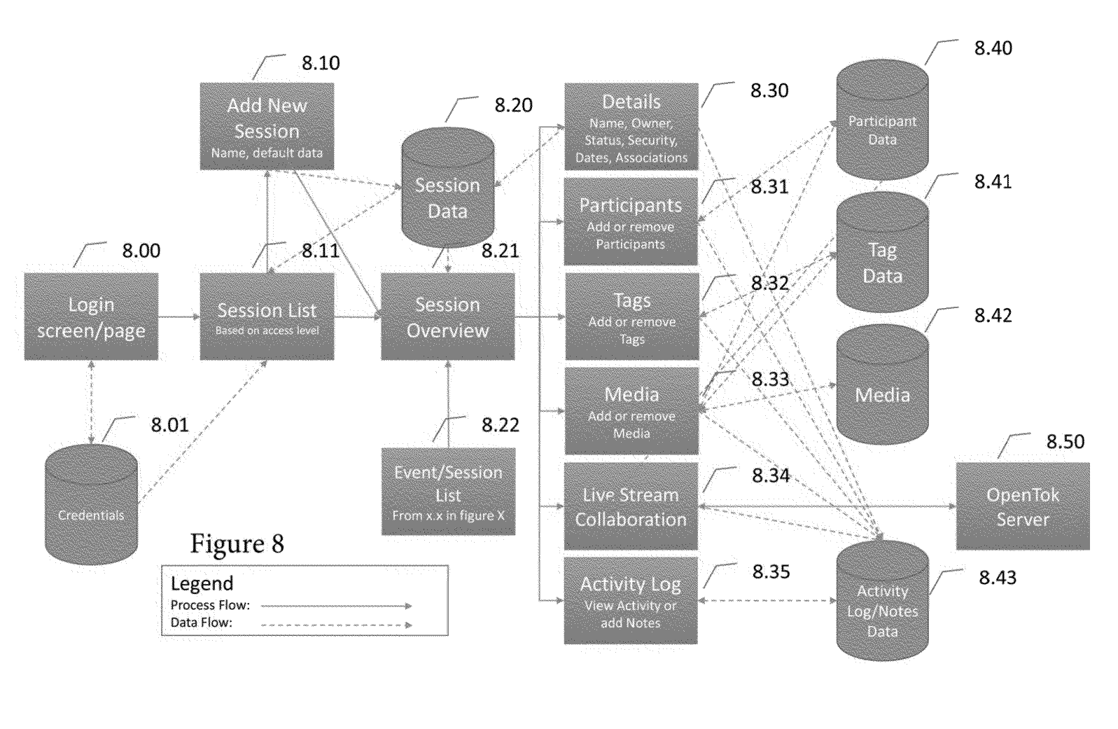

FIG. 9 illustrates an example embodiment of the Events List, with the navigation tabs at the top of the page called out;

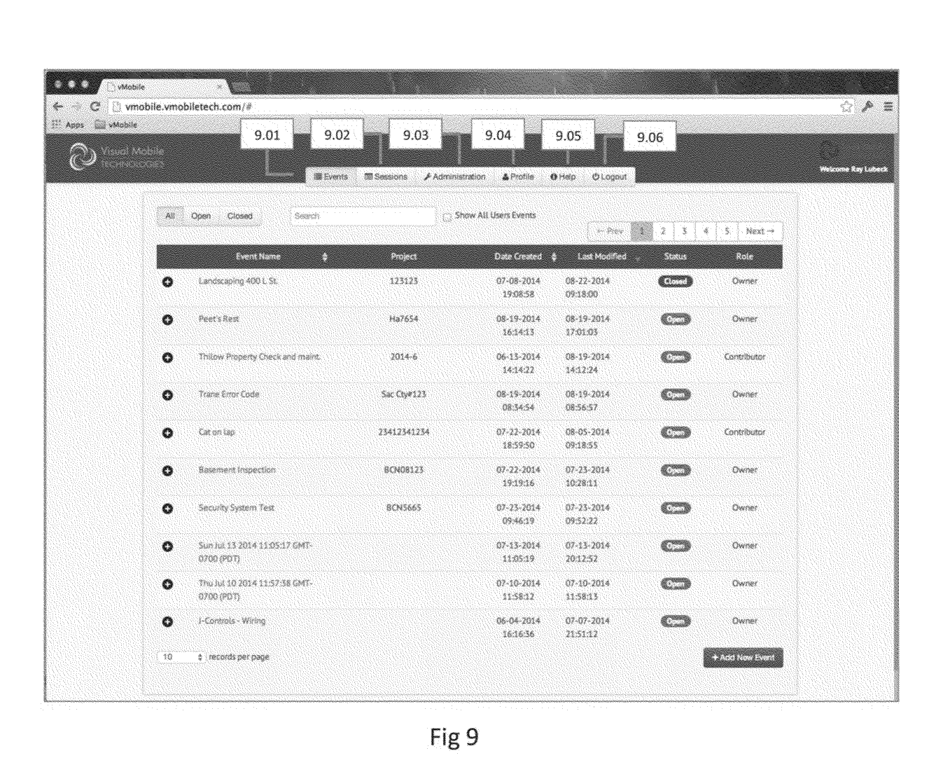

FIG. 10 illustrates an example embodiment of the Events List, with the Search field called out;

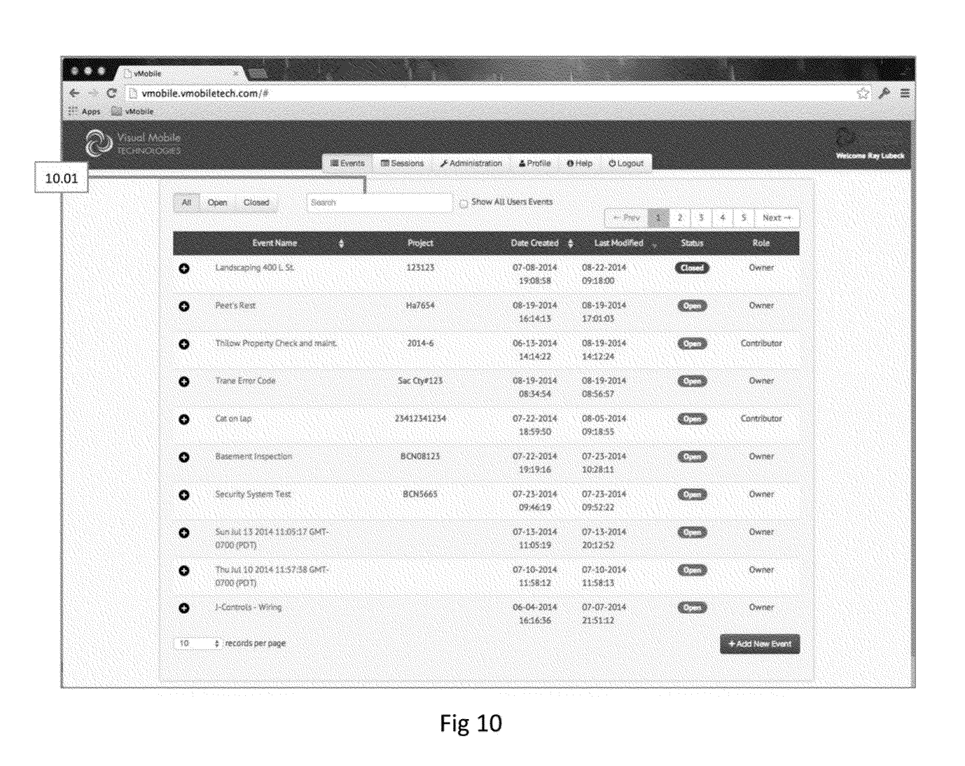

FIG. 11 illustrates an example embodiment of the Events List, with a character string entered in the Search field, and the corresponding matching Events displayed on the list (in this case, the string “water” appears somewhere in any field within each of the Events displayed on the list);

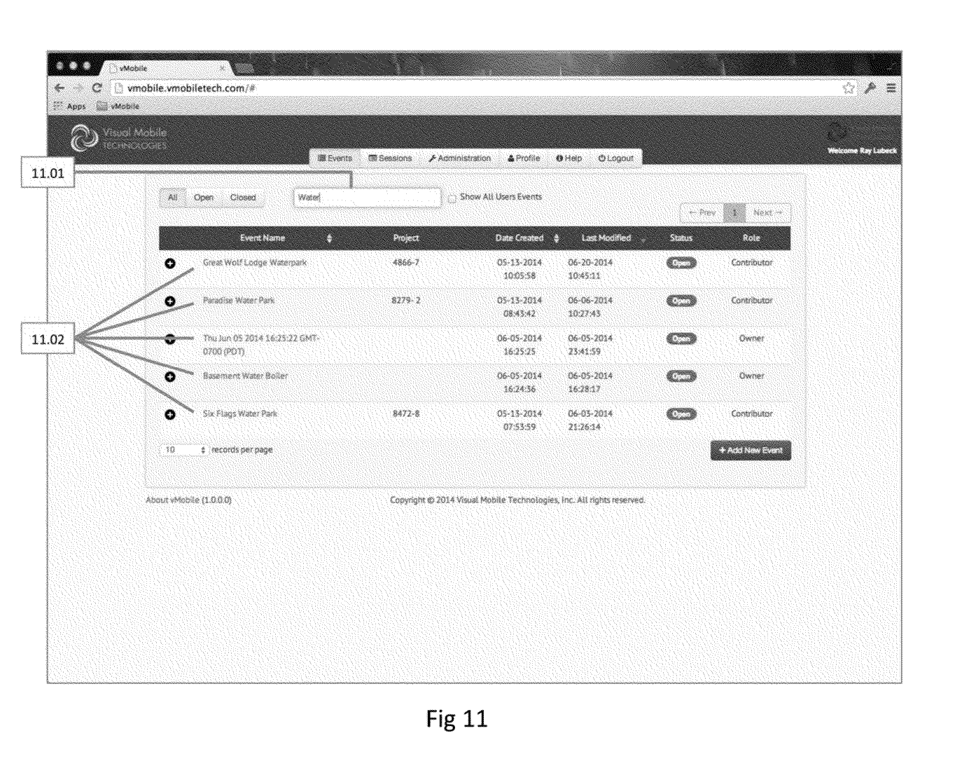

FIG. 12 illustrates an example embodiment of the Events List, with the “Show All Users Events” box checked;

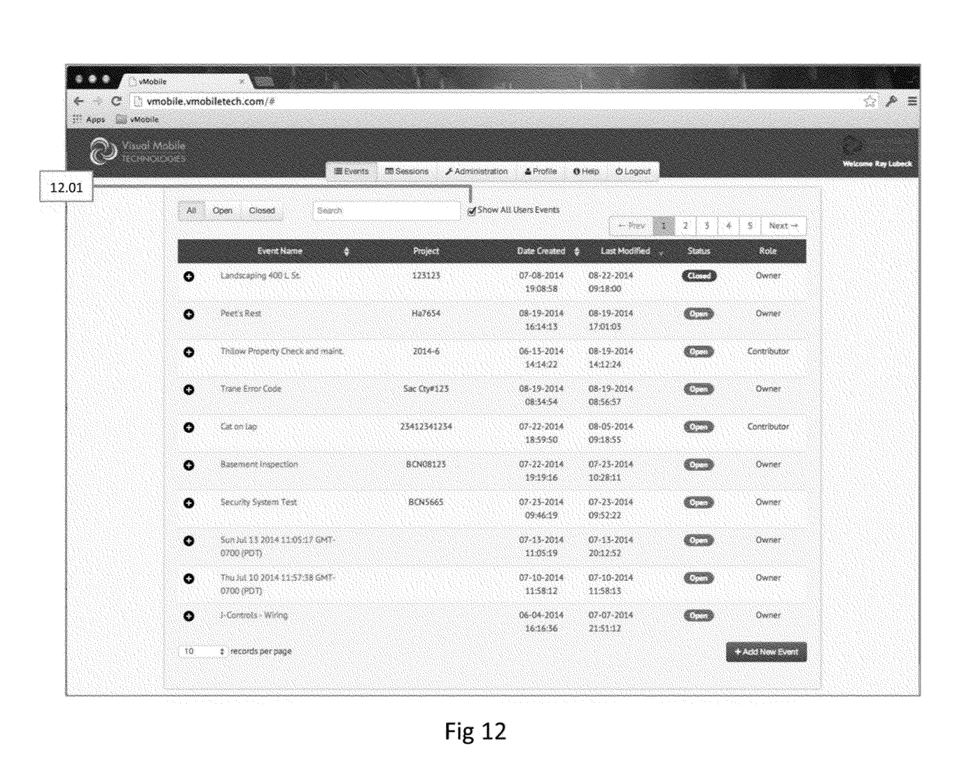

FIG. 13 illustrates an example embodiment of the Events List, with the “Add New Event” button called out;

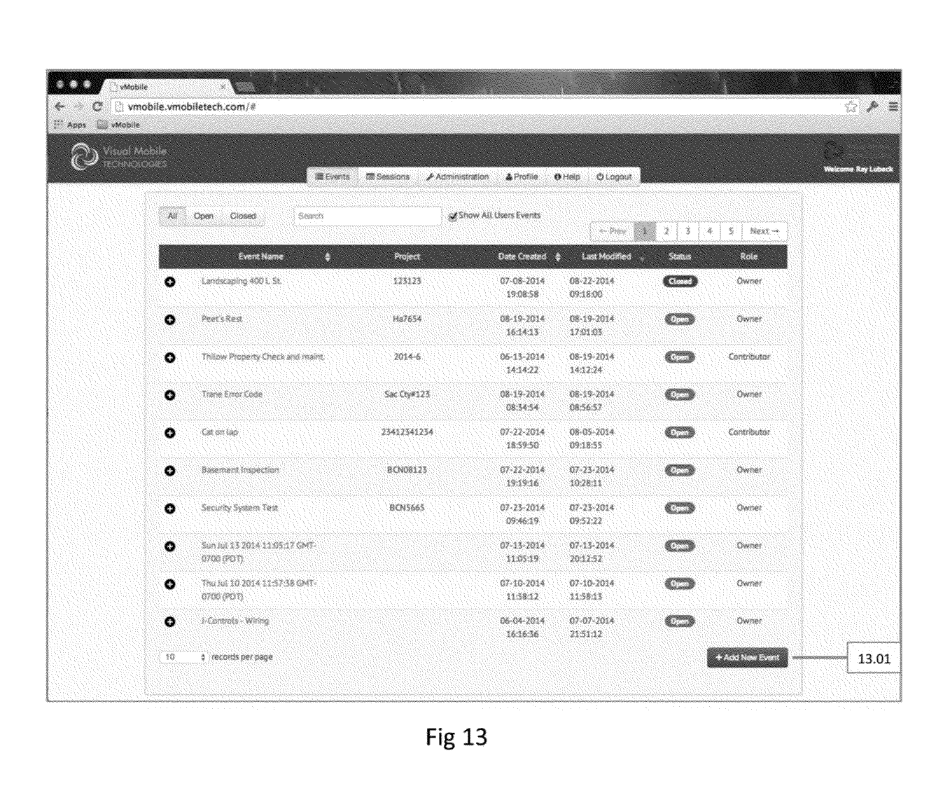

FIG. 14 illustrates an example embodiment of the Add New Event pop up window displayed calling out the Event Details tab;

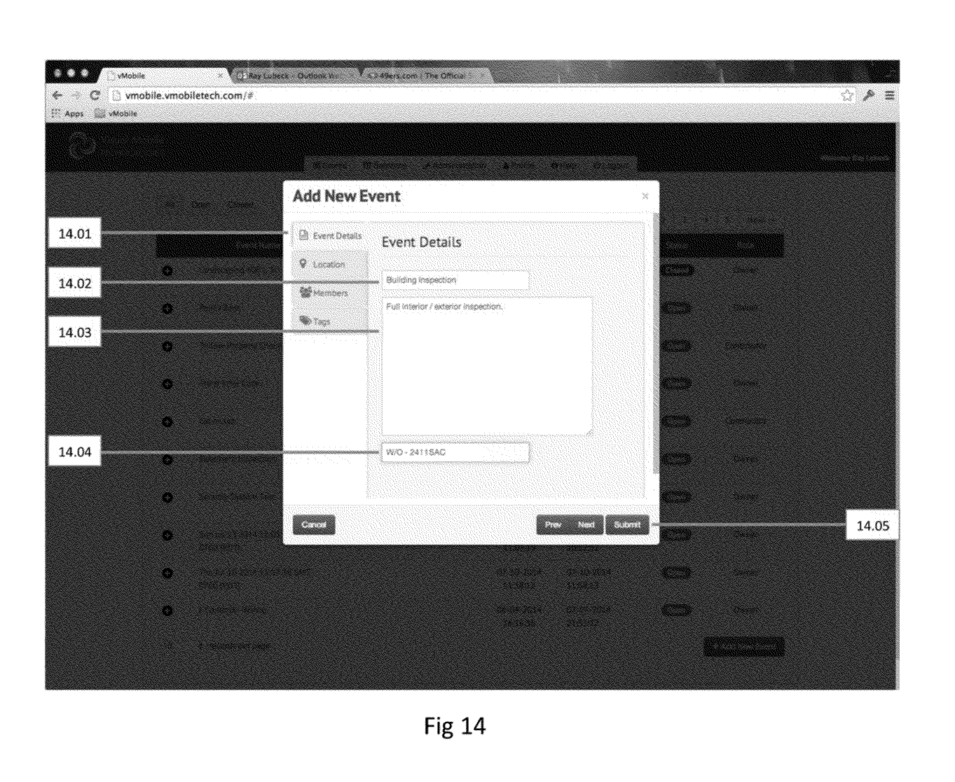

FIG. 15 illustrates an example embodiment of the Add New Event pop up window displayed calling out the error received when Location information has not been provided;

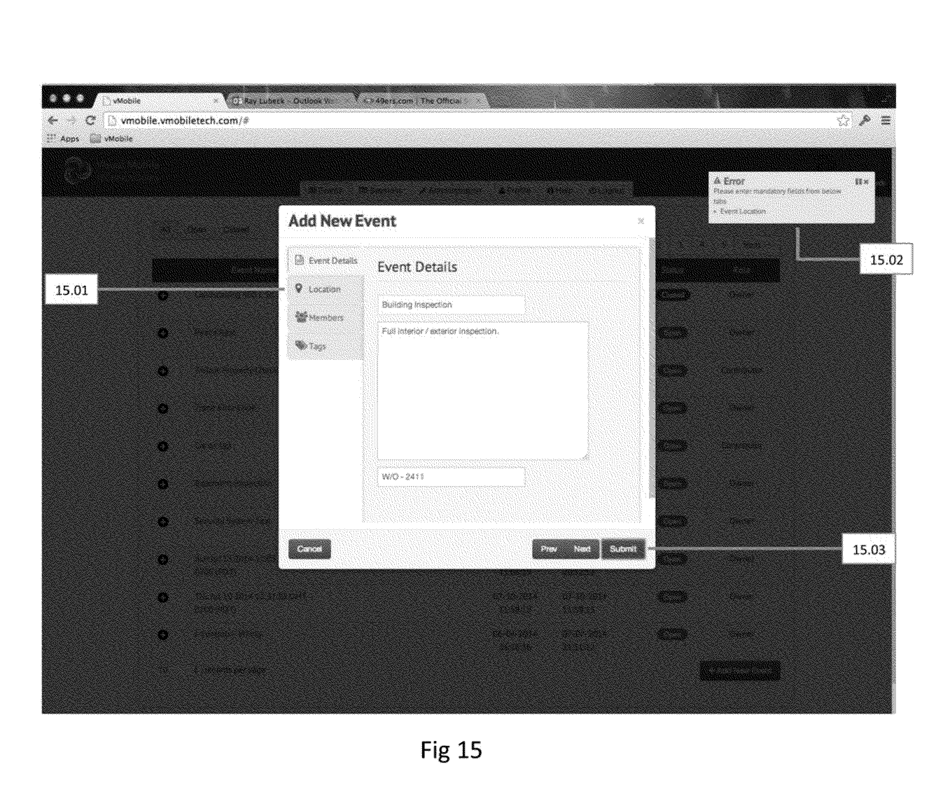

FIG. 16 illustrates an example embodiment of the Add New Event pop up window displayed calling out the Location tab;

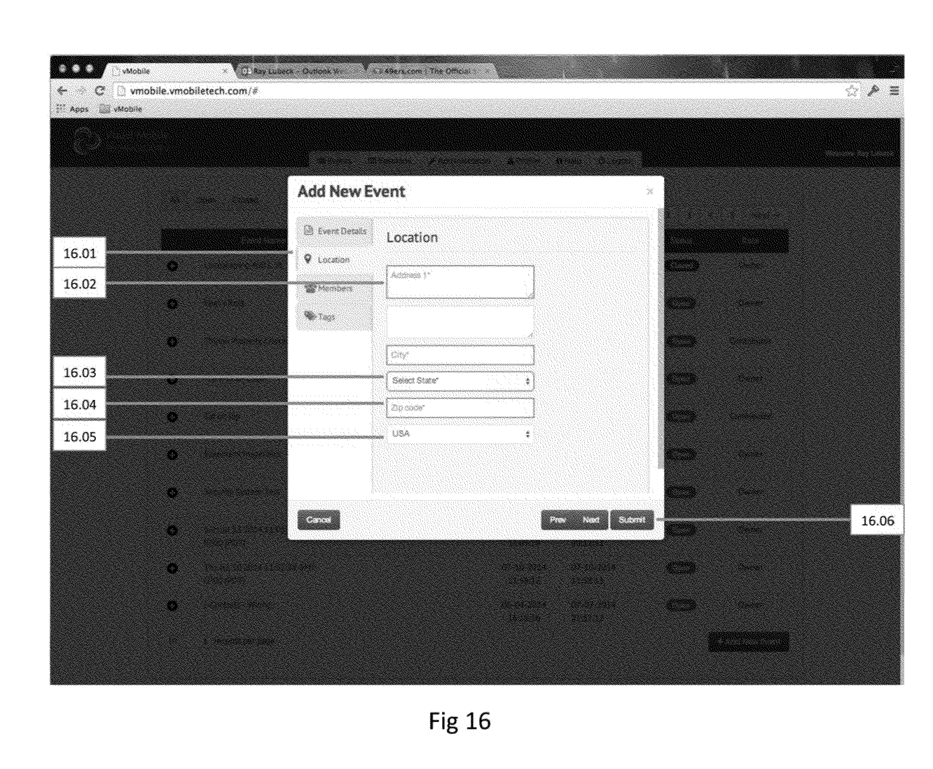

FIG. 17 illustrates an example embodiment of the Add New Event pop up window displayed calling out the Location tab and the pull down list of valid States;

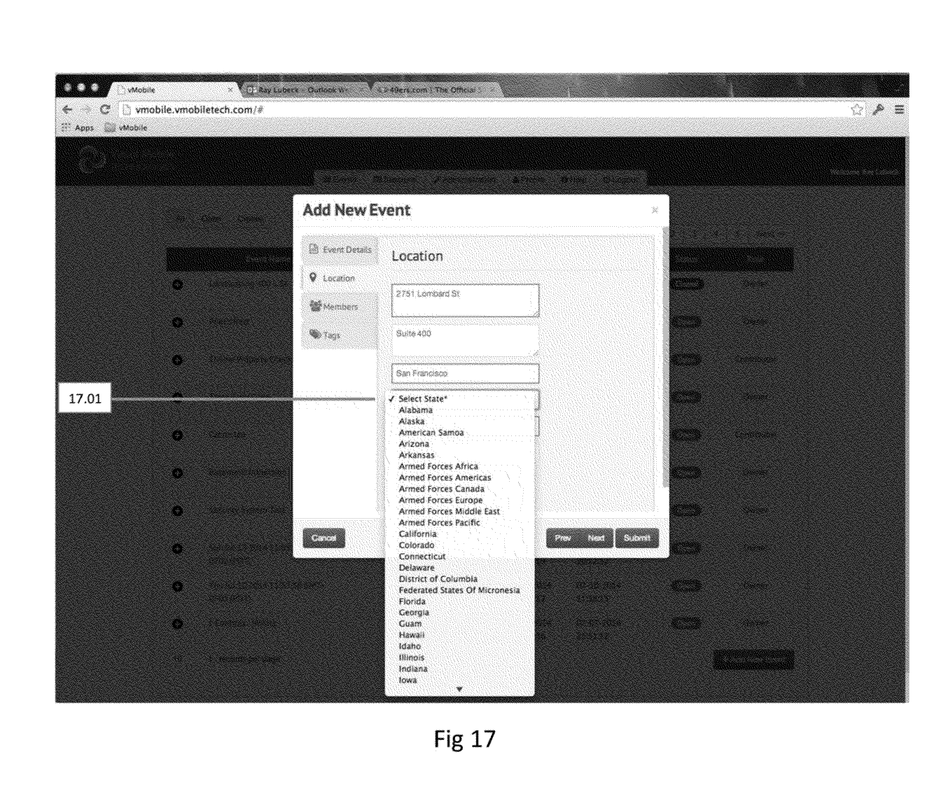

FIG. 18 illustrates an example embodiment of the Add New Event pop up window displayed calling out the Location tab and the pull down list of valid Countries;

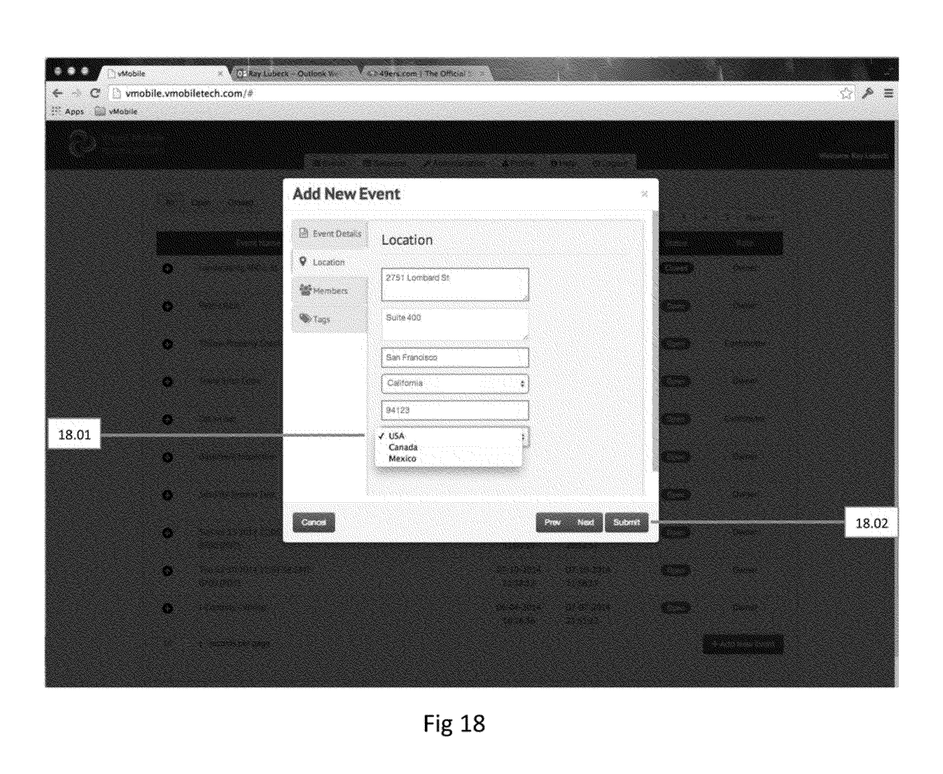

FIG. 19 illustrates an example embodiment of the Add New Event pop up window displayed calling out the Members tab;

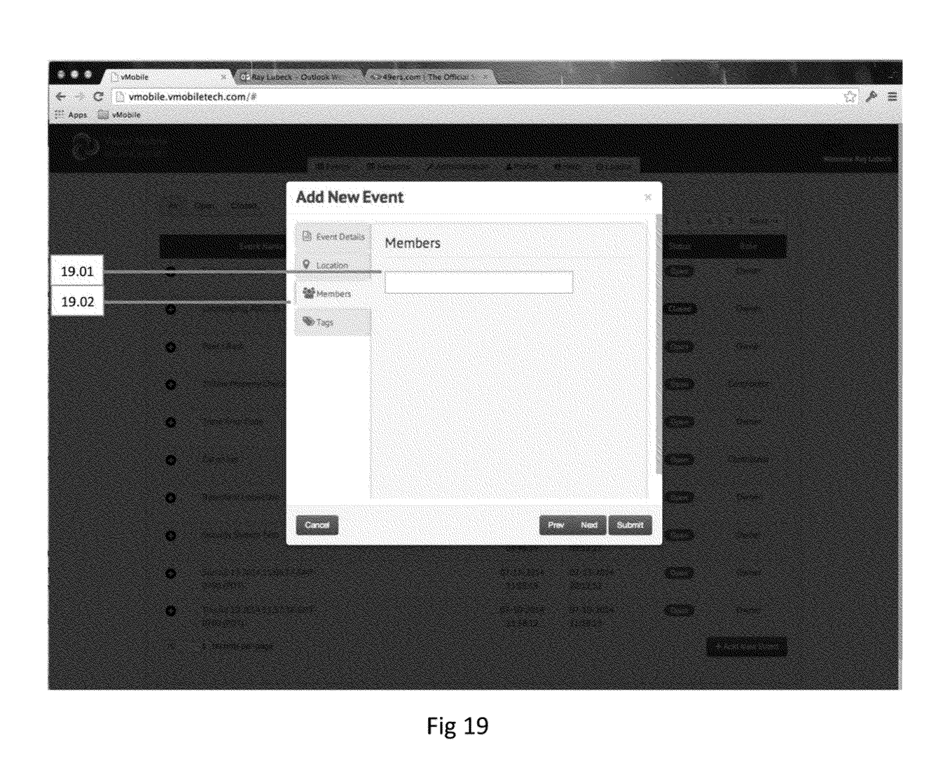

FIG. 20 illustrates an example embodiment of the Add New Event pop up window displayed calling out the Members tab, with a list of valid Users whom may be added as Members;

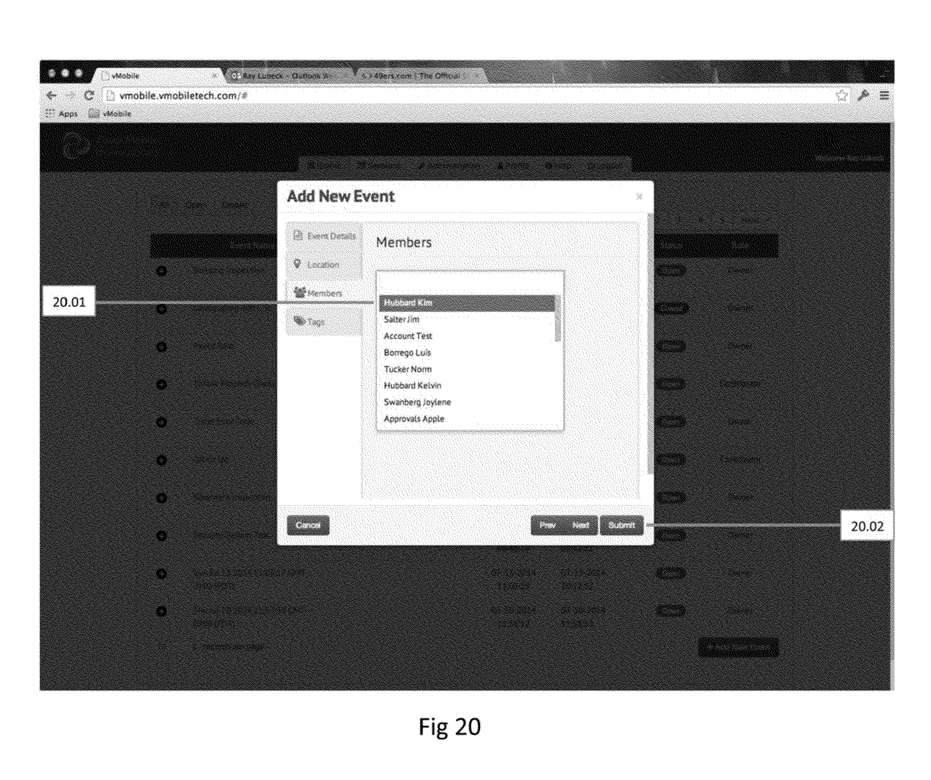

FIG. 21 illustrates an example embodiment of the Add New Event pop up window displayed calling out the Tags tab;

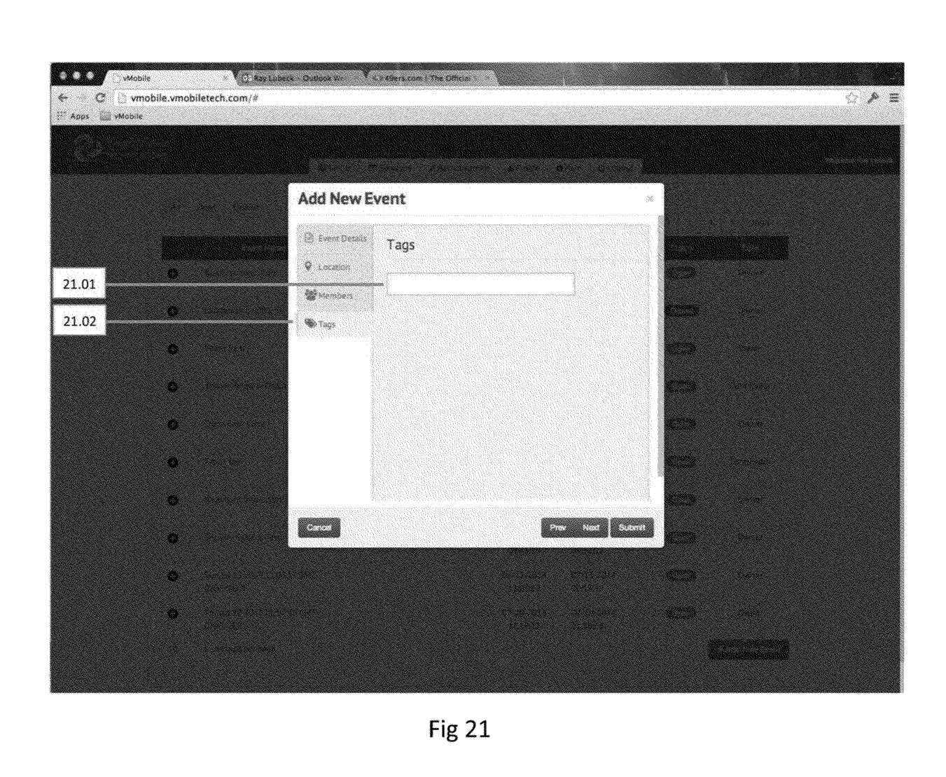

FIG. 22 illustrates an example embodiment of the Add New Event pop up window displayed calling out the Tags tab, with a list of pre-defined Tags from which to select;

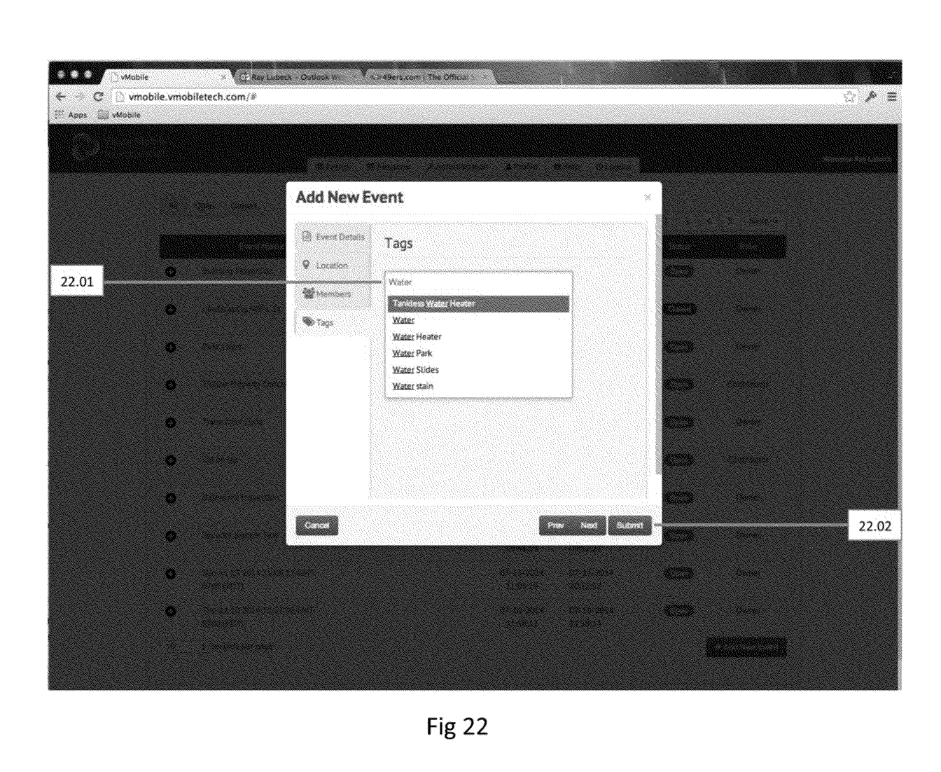

FIG. 23 illustrates an example embodiment of the Add New Event pop up window displayed calling out the Tags tab, with a list of pre-defined Tags to select from and the “Submit” button called out;

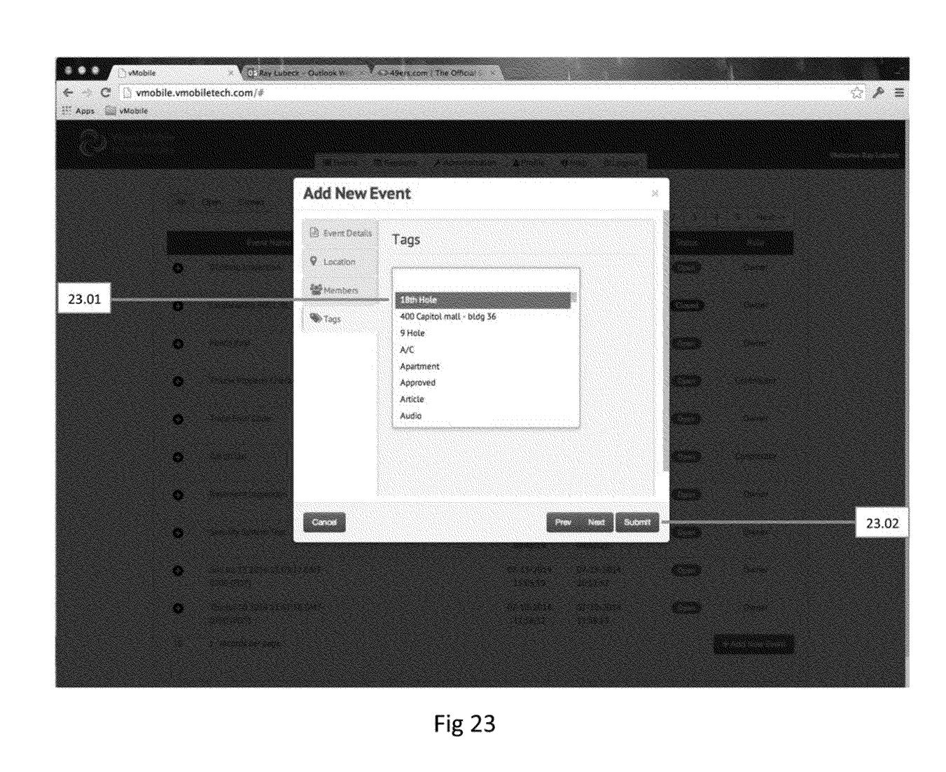

FIG. 24 illustrates an example embodiment of the Events List, with a particular Event called out;

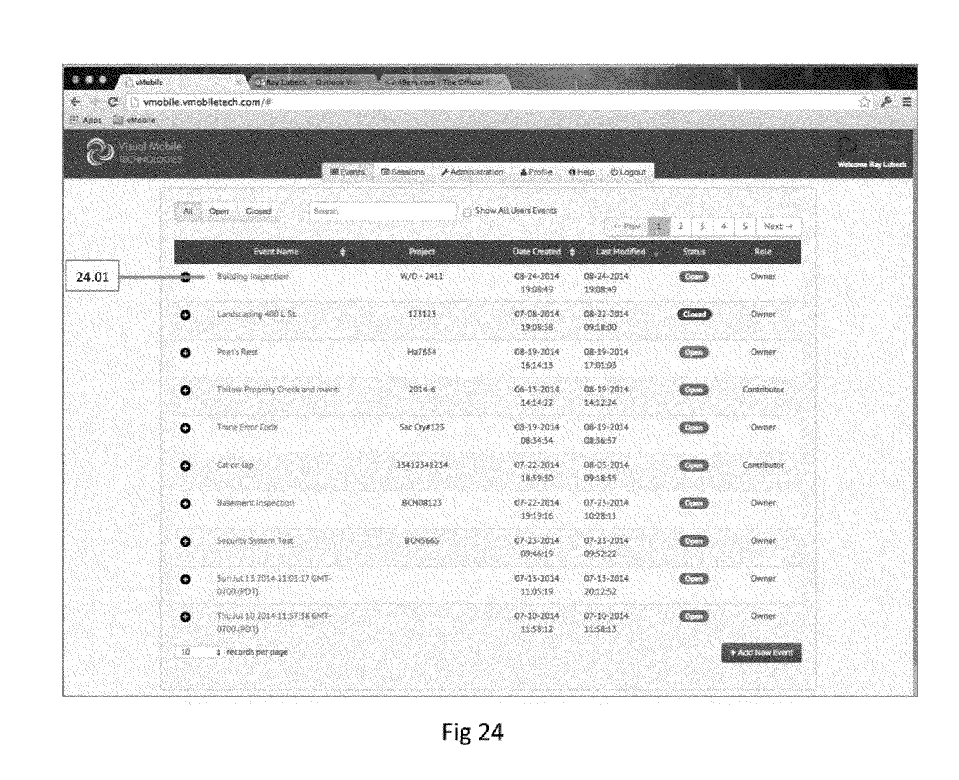

FIG. 25 illustrates an example embodiment of the Event Details tab activated and various fields, tabs, and buttons called out;

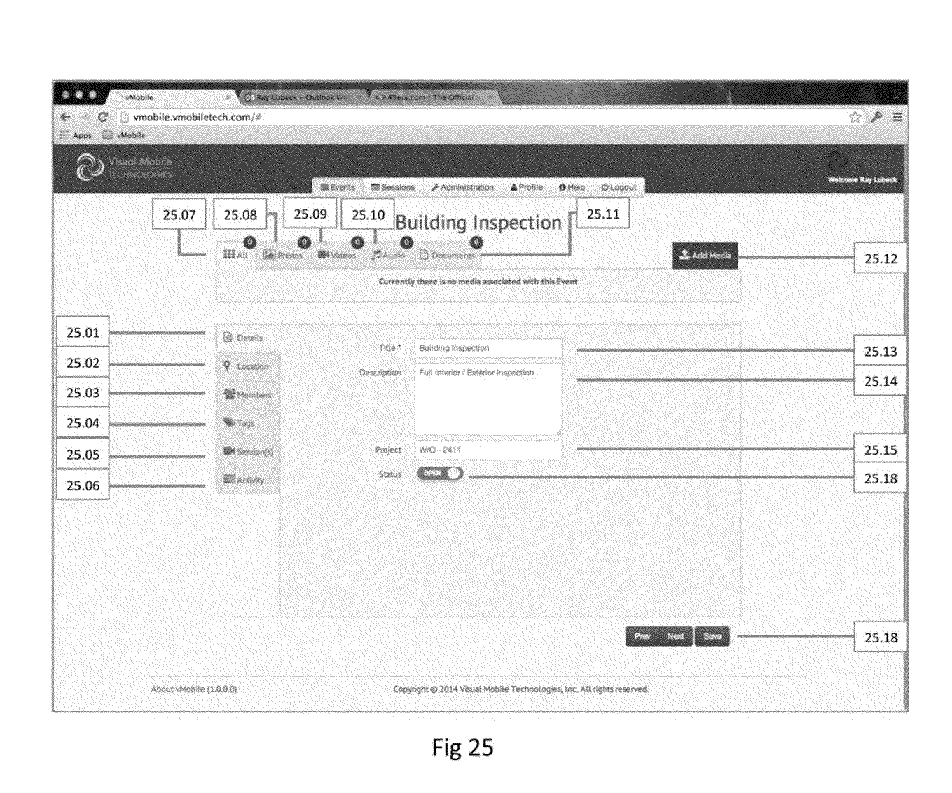

FIG. 26 illustrates an example embodiment of the Sessions List, with a character string entered in the Search field and the corresponding Sessions displayed (in this case, the string “water” appears somewhere in any field within each of the Sessions displayed on the list—only one);

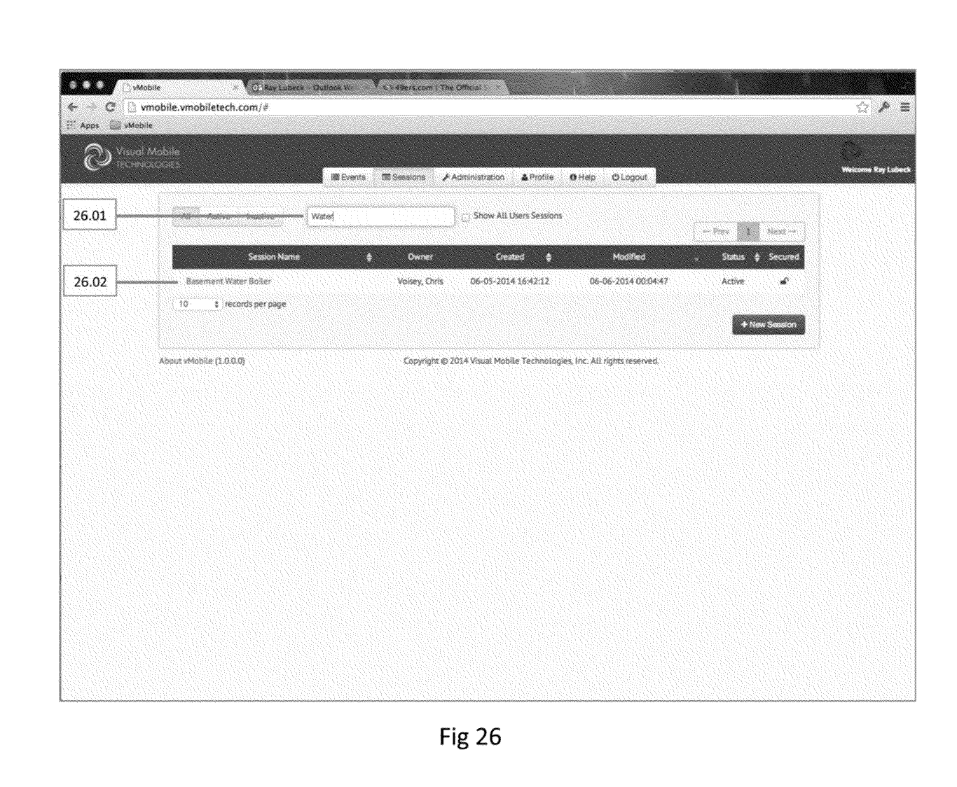

FIG. 27 illustrates an example embodiment of the Sessions List, with the “Show All Users Sessions” box checked;

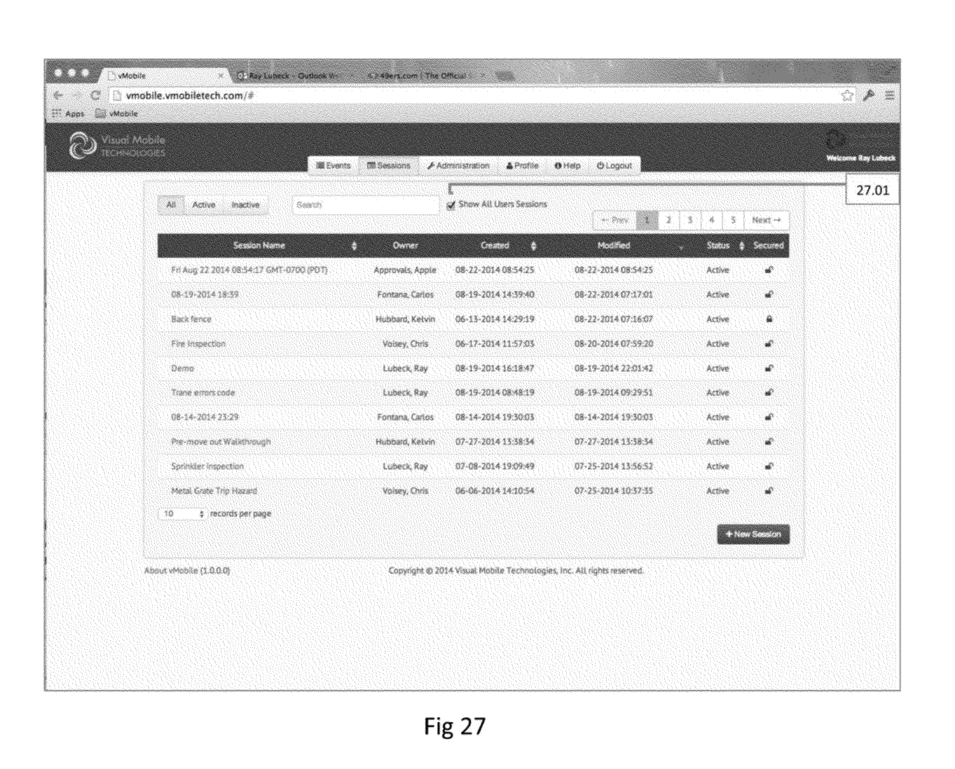

FIG. 28 illustrates an example embodiment of the Sessions List, with the “+New Session” button called out;

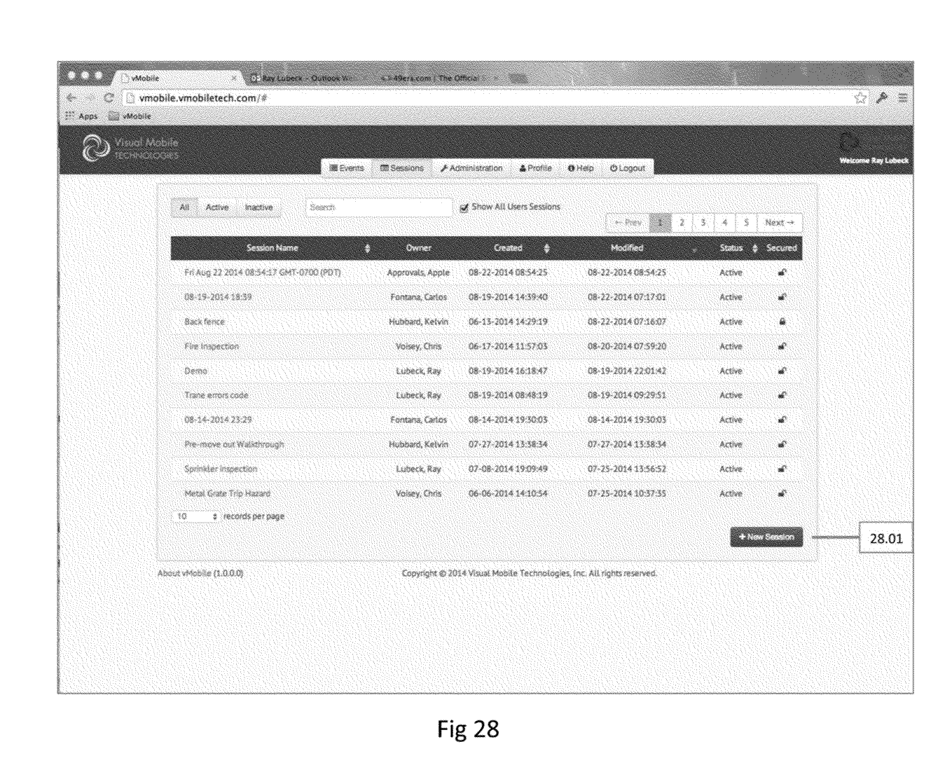

FIG. 29 illustrates an example embodiment of the Create New Session pop up window displayed calling out the Details tab, with various fields and buttons called out;

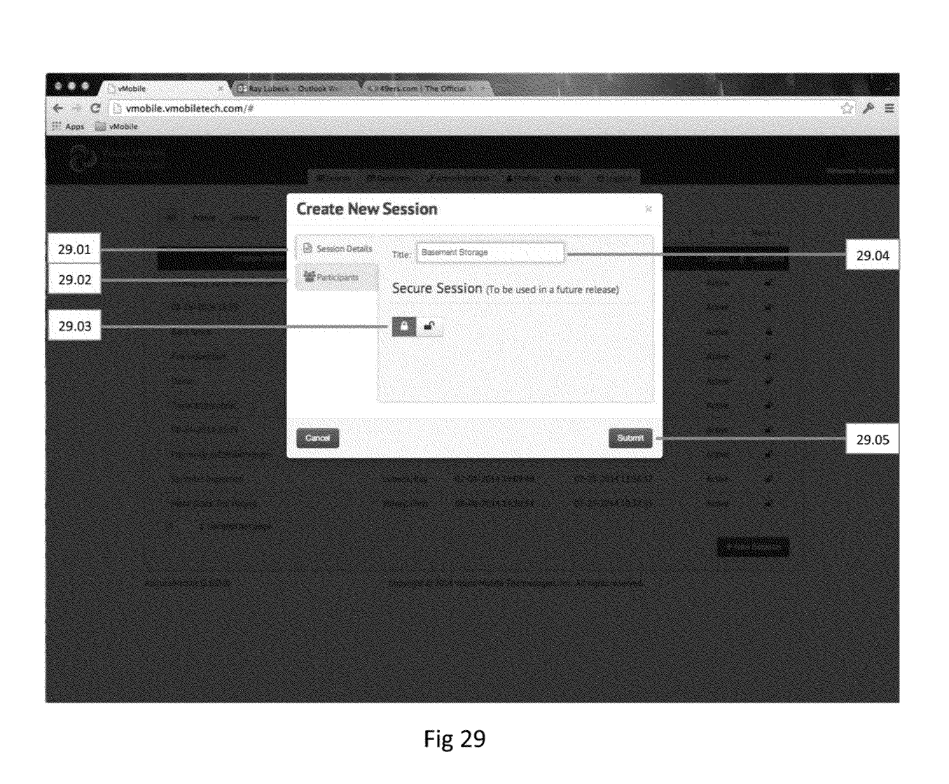

FIG. 30 illustrates an example embodiment of the Create New Session pop up window displayed calling out the Participants tab;

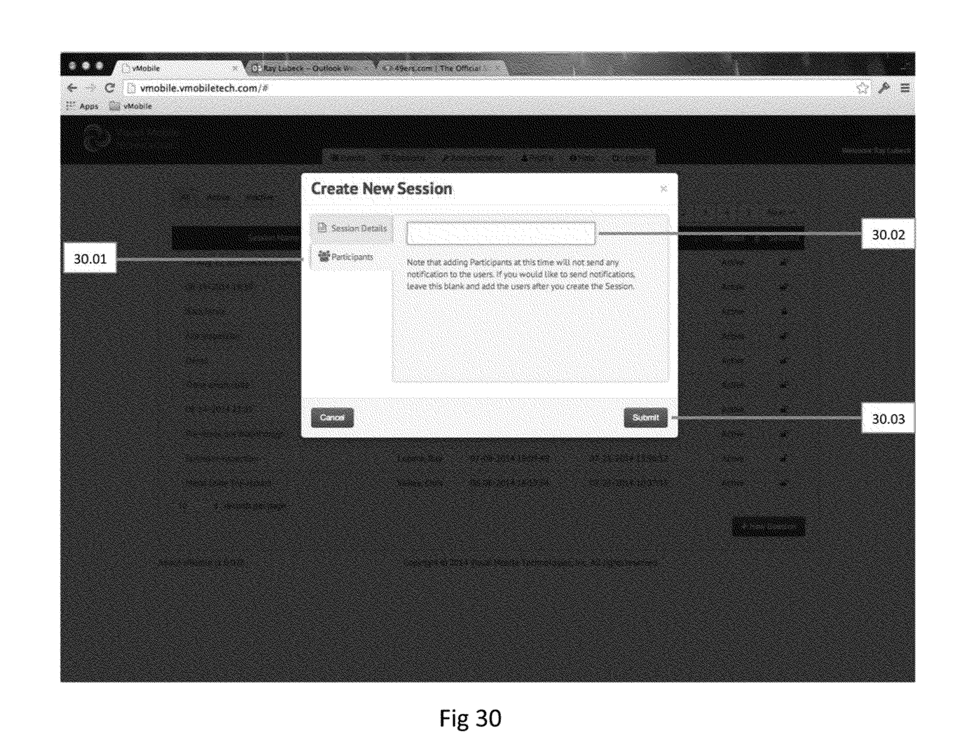

FIG. 31 illustrates an example embodiment of the Create New Session pop up window displayed calling out the Participants tab, with a list of valid Users whom may be added as Participants;

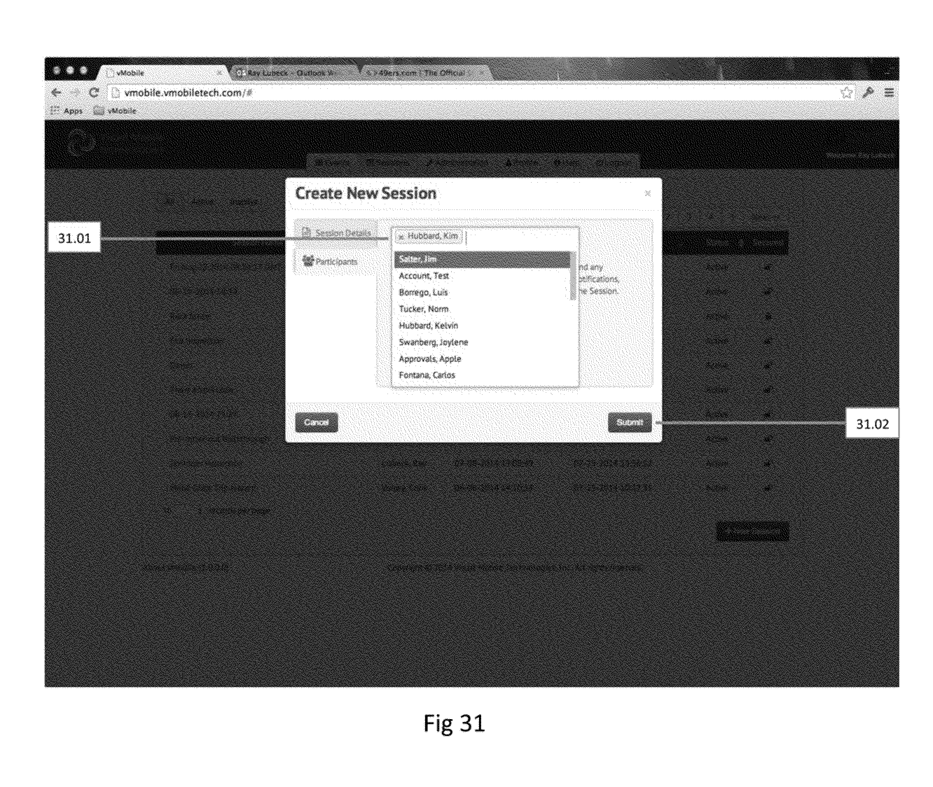

FIG. 32 illustrates an example embodiment of the Sessions Overview page with various call outs showing the tabs, fields, and buttons on the page;

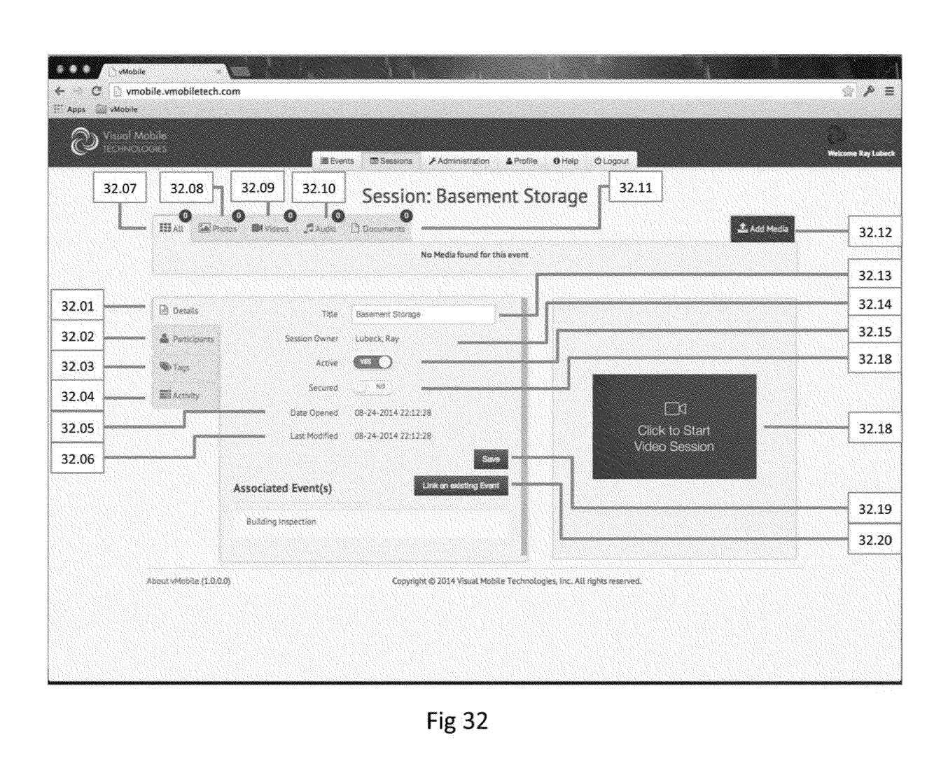

FIG. 33 illustrates an example embodiment of the Sessions Overview page with the “Change” Owner button called out;

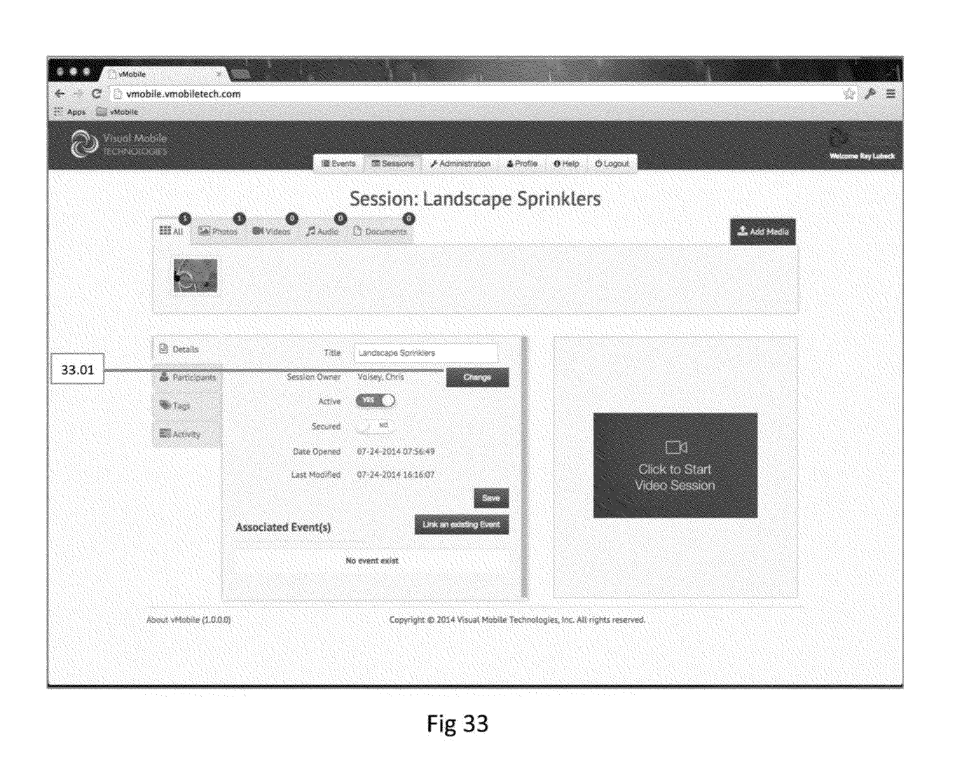

FIG. 34 illustrates an example embodiment of the Sessions Overview page and the “Change Admin” pop up window showing a list of valid Participants that may be made the Owner of the Session;

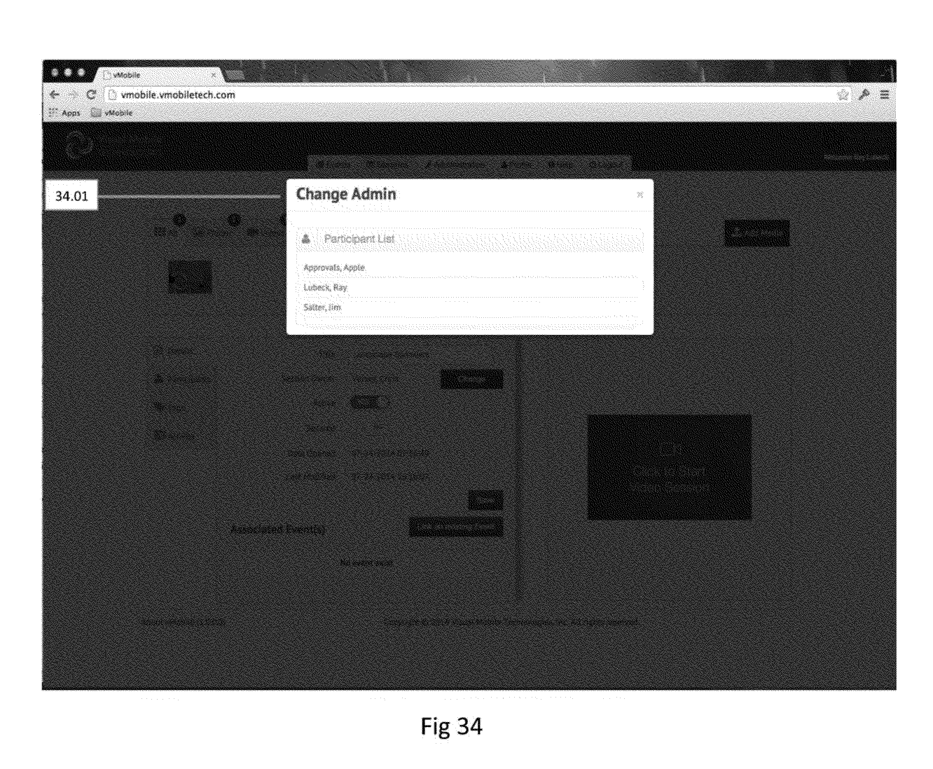

FIG. 35 illustrates an example embodiment of the Sessions Overview page with Details tab engaged and the “Active” slider called out;

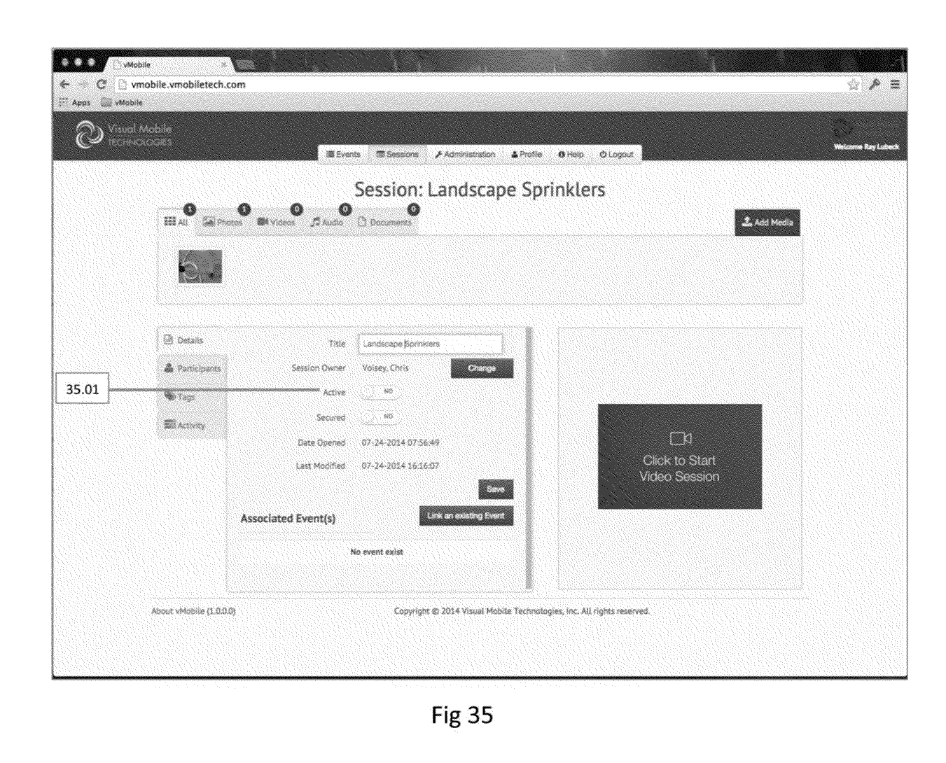

FIG. 36 illustrates an example embodiment of the Sessions Overview page with Details tab engaged and the “Secured” slider called out;

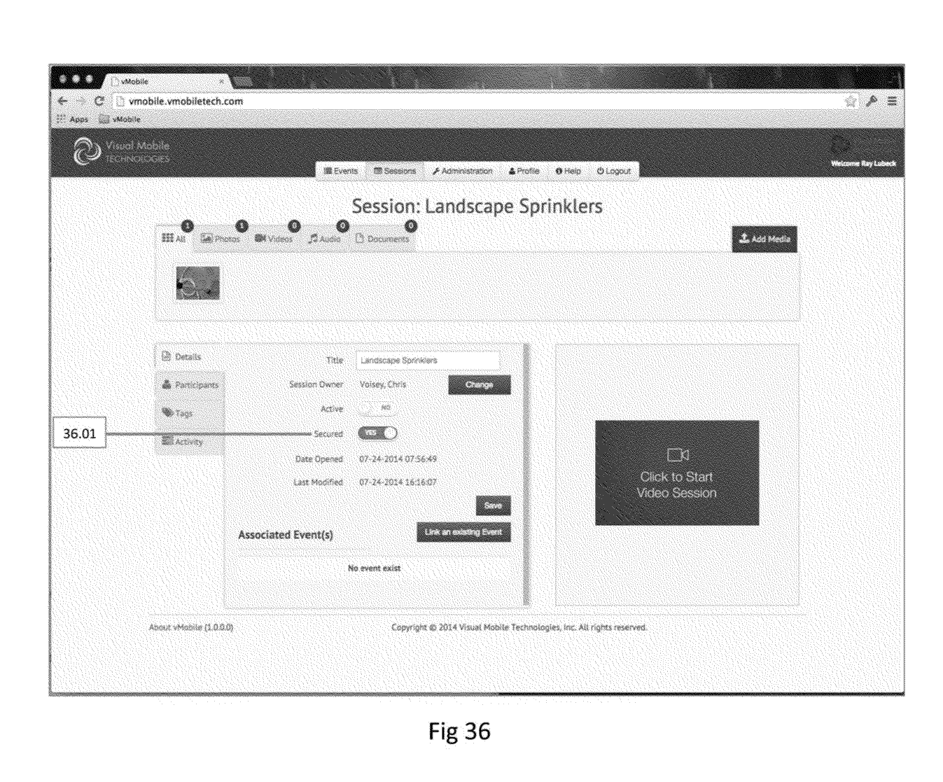

FIG. 37 illustrates an example embodiment of the Sessions Overview page with Details tab engaged and the “Associated Event(s)” List called out;

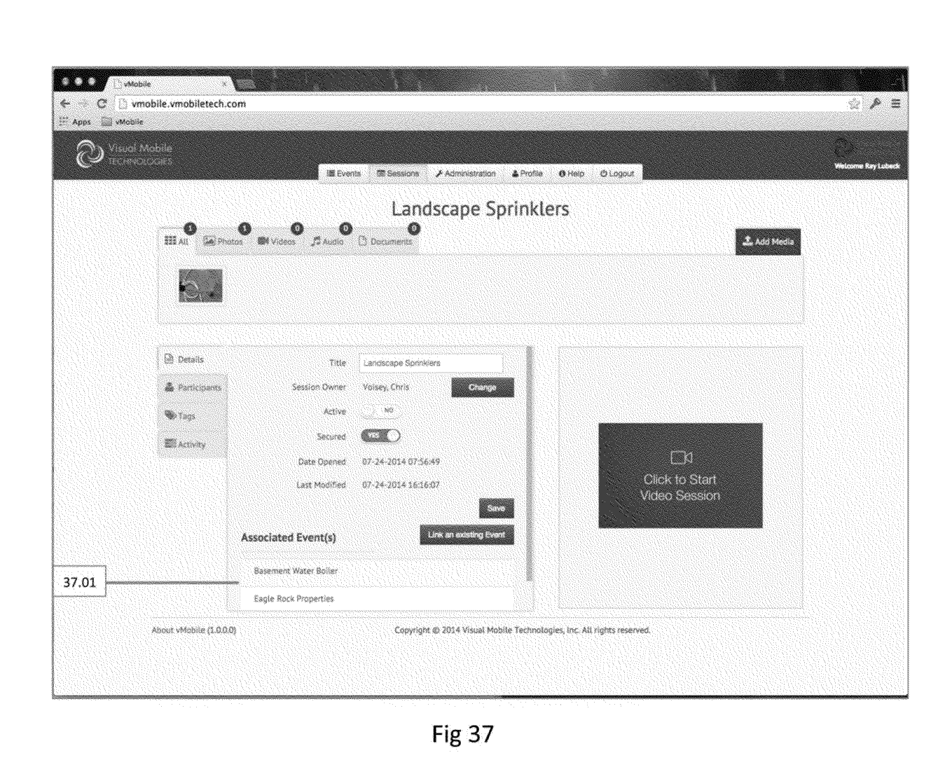

FIG. 38 illustrates an example embodiment of the Sessions Overview page with Details tab engaged and the Add “Associated Event(s)” pop up window displayed showing Events that are currently associated with the Session and Events that may be associated with the Session. An already associated Event is called out;

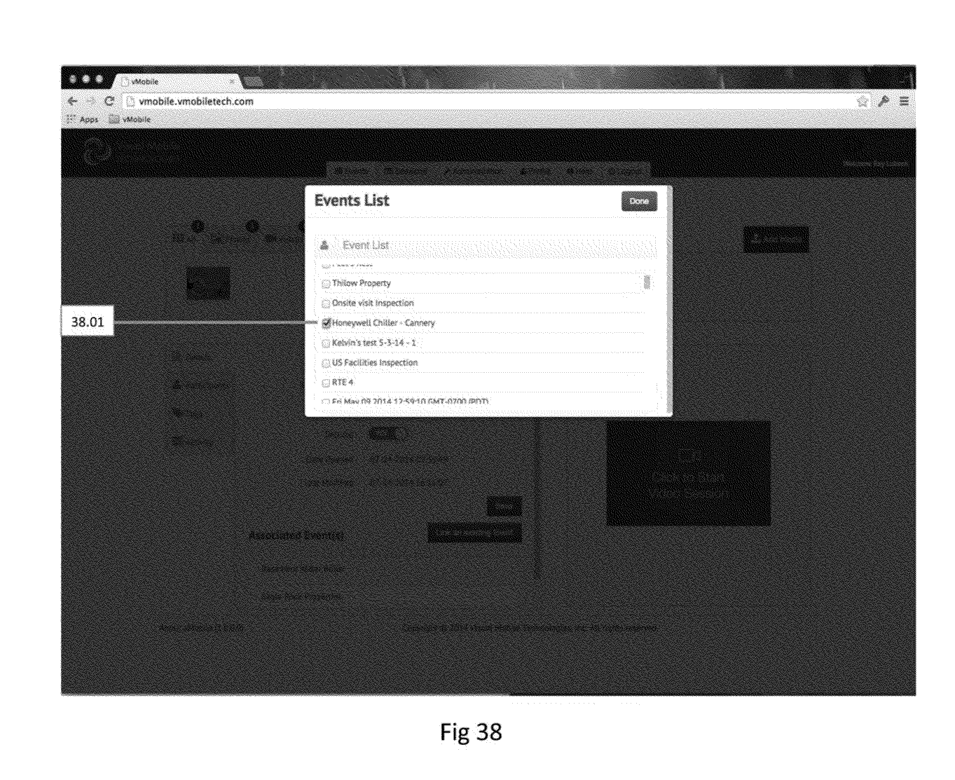

FIG. 39 illustrates an example embodiment of the Sessions Overview page with Details tab engaged and the Add “Associated Event(s)” pop up window displayed showing Events that are currently associated with the Session and Events that may be associated with the Session. An Event that has been removed from the association with the Session is called out;

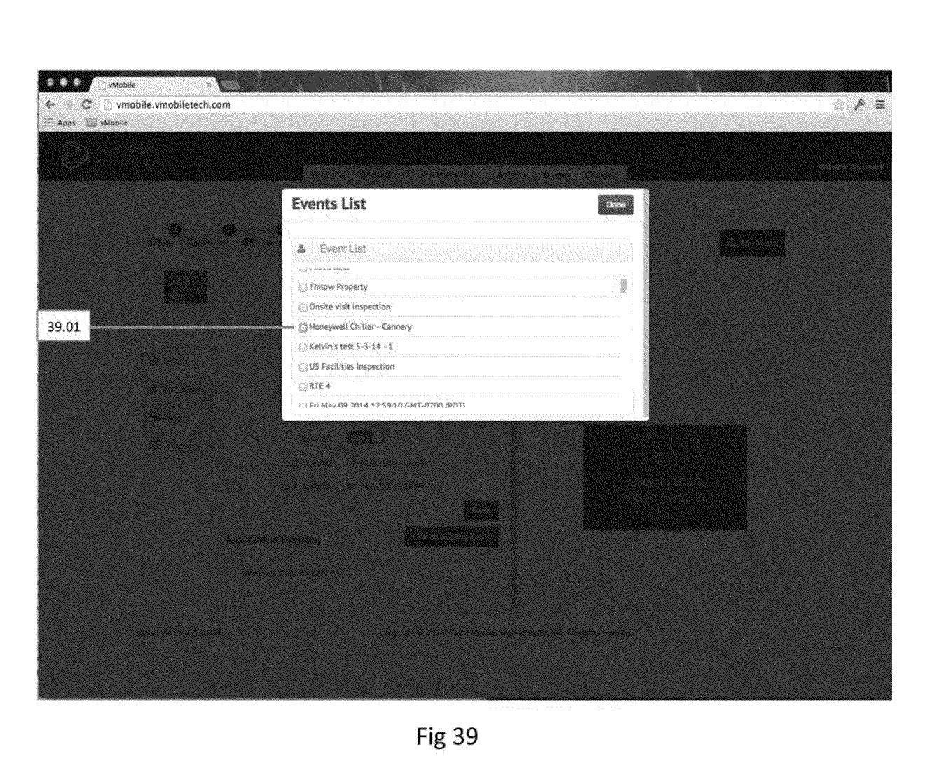

FIG. 40 illustrates an example embodiment of the Session Overview page with the Participants tab called out and the “All” Participants List engaged, showing a list of all Users that may be added as Participants; and

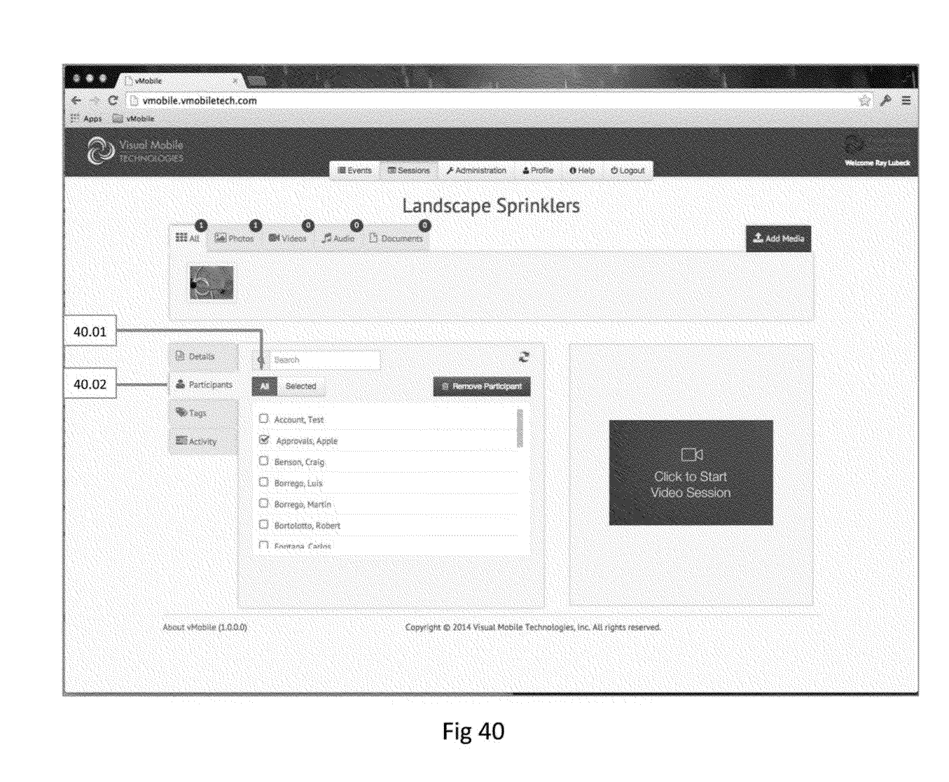

FIG. 41 shows a diagrammatic representation of a machine in the example form of a stationary or mobile computing and/or communication system within which a set of instructions when executed and/or processing logic when activated may cause the machine to perform any one or more of the methodologies described and/or claimed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method for content collection, cataloging, and collaboration are disclosed. The various embodiments improve a remote interaction delivered using data storage and network technologies between a provider and a consumer.

In various embodiments described in detail below, a software application program is used to gather, process, and distribute data using a computer system, a web appliance, and/or a mobile device. As described in more detail below, the computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, set-top boxes, consumer electronic devices, or any other type of computing, data processing, communication, networking, or electronic system.

### Definition of Terms

vMobile Collaborator: The name of the application of an example embodiment, which is a combination of a mobile application, a web application, backend databases, and a third-party audio and video platform, accessible only with proper credentials.

Administrator: A role in the vMobile Collaborator system, used for persons who have been granted authorization to access to administrative functions, as they are able to edit Company information, set up new users, change user information, and access all Events/Sessions/Media within the system.

User: (1) A named person set up in the system with a user id and password; (2) A role in the vMobile Collaborator system, used for the lowest level of access (not able to do Administrator functions).

Associate: The act of linking two or more disparate entities (Event/Session, Media/Event, Member/Event, Participant/Session, etc.).

Associated User: A user of the system that is ‘registered’ under one company (customer), but is associated with one or more other companies (customers) for the purpose of collecting data for all companies (customers) to which the user is either ‘registered’ or associated.

Member: A User that has been given access to an Event.

Guest: A person who is not a User, but has been given access to a Session.

Participant: A User (or Guest) that has been given access to a Session

Owner: The person who has created (or been given ownership) of an Event, Session, or Media.

Event: A happening (problem, issue, inspection, etc.) that is usually associated with a physical location and identifiable by an address.

Session: A way to organize information about an Event, or which may be kept separately, if the creation of an Event is not necessary (e.g. If an Event is created for “Pebble Beach Golf Club”, one might create Sessions for each of the 18 holes, another for the Clubhouse, and another for the Parking Lot, wherein videos, images, documents, Tags, and Notes may be kept). Additionally, a Session is where a User may conduct a Collaboration using the Live Stream capabilities within the application.

Collaboration: The act of two or more vMobile Collaborator Participants working together within a Session, usually using the Live Stream capabilities of the application.

Live Stream: The use of video and audio live streaming between two or more Participants in a Session. Participants may be a User or a Guest, one of which is the Moderator.

Moderator: The Participant in a Session using the Live Stream capability who has initiated the Collaboration, and controls who is the Publisher at any given time.

Publisher: The Participant in a Session using the Live Stream capability who is using their mobile device to share live video and audio with the other Participants of the Live Stream.

Publish: The term used to describe the person who's camera is active, and the other Participants of the Session (who are also using the Live Stream capability) will see the video being captured (viewed) through their mobile device's camera and all Participants will hear each other's audio.

Notes: A construct used to hold information in a free-form manner about an Event, Session, or Media, which is entered by a User, and is NOT modifiable once created. A Note is Date/Time stamped and tagged with the username of the User that has created it.

Tags: Used to keep metadata about an object in the application, which is usually one or more words that helps other Users find and understand the object.

Media: Digital content that may be captured by a User (either with their mobile device or uploaded with the Web Application) and may stand alone, or be associated with an Event or a Session. Media is always tagged by default with username, Date/Time, and Location.

Activity: An Audit Log of entries which identify any additions, modifications, or deletions that happen within the application. Once created a Log entry may be viewed, but never modified or removed.

Group: A named collection of Users created for the purpose of assigning multiple Users to an Event, Session, Notification, or other access privilege within the application.

vMCC (vMobile Control Center): A screen created as part of the mobile application, which allows the User to access different parts of the application more quickly, as well as control certain aspects of their environment.

Reference ID label: A field within the Company Administration that may be defined, which will then become the label for a field within the Event, which may be used to better identify an Event. Examples include Project number, Claim number, Customer number, Job code, etc.

Invitation: A hyperlink sent electronically (SMS, Email etc) granting a User, Member or Participant the ability to access content associated with either a Session or an Event.

### Web Application

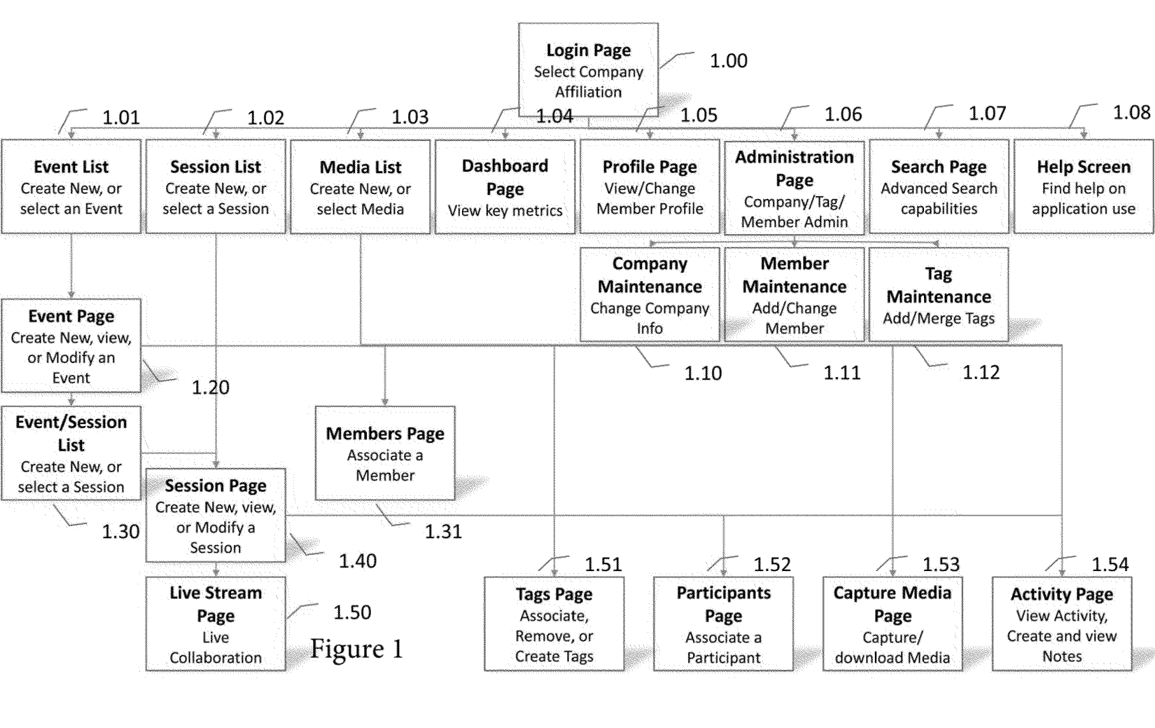

With reference to FIG. 1 and the flow of the process, and as it pertains to the use of either the web or the mobile applications, before the user can begin using the vMobile Collaborator system and applications (either through the web or mobile application), some initial setup work must be completed by the implementation team, including initializing the database to accept information and digital content, creating the company, and setting up at least one User with the role of Administrator.

### Implementation

As mentioned above, before a user (with the role of Administrator) can create new users, at least one Administrator must be created within the vMobile Collaborator application by the implementation team.

### User Administration

Additional Administrators may be set up by any user with the role of Administrator within the user's company after the initial Administrator is set up. To create a new user, a user (with the role of Administrator) may navigate to the Administration page of the web application and select the “Users” tab. Selecting “Add New User” at the bottom of the page will cause the “Add New User” pop-up window to appear for the user, allowing entry of the new user's information.

The user may then enter the email address of the new User. This is their primary ID for the system, and will be the default email address used to send invites to the User when email is chosen as the method of invite delivery or when a password reset is requested.

The User may then select the Role for which this User will be responsible. As an “Administrator”, the User will be able to do administrative tasks, such as add new Users, create groups, change company colors, change company logo, as well as see other Users' Events, Sessions, & Content. Valid Roles are displayed in a pop-up list. Current valid roles include Administrator and User. However, future roles will include such things as a “view only” role, additional guest roles, audit roles, reporting roles, and management roles.

The User must then enter the first name of the new User. This will be used for display purposes in the application, and when sending or receiving invites.

The User then must enter the last name of the new User. This will be used for display purposes in the application, and when sending or receiving invites.

The User may then enter the mobile device phone number for the new User, which will be used to send them invites when a text invite is chosen.

If during creation of a new member the User decides to cancel the entry, they may select the “Close” button, and they will be returned to the previous page. The new member will not be created in the system.

When the User has completed the creation of the new User, they may select the “Submit” button, which will cause the new User to be created in the system, and they will be returned to the previous page.

Once a new User or Users have been entered into the system, the User may maintain information about them by using the same “Users” tab, and selecting a User from the list of valid Users. The list may be filtered by “All” Users, “Active” Users, or “Inactive” Users, making it easier to find the User they are looking for. When they find the desired User, they may select the User by clicking on them on the list.

The “User Details” tab is where certain information about a User can be entered and edited, such as their name, email address, role, phone number, and Active status. The User Details for the selected User will appear to the right of the list of Users.

Once a User has been created, the new user's Email Address may not be changed, as this is the primary way they are identified within the system. If they need to change their Email Address, they must be set to “Inactivate”, and then add them as a new User with their new Email Address.

The role of any User may be changed by any other User with the role of Administrator by selecting the Role field, and selecting a “Role” from the pull-down list. As an “Administrator”, the User will be able to do administrative tasks, such as add new Users, create groups, change company colors, change company logo, as well as see other Users' Events, Sessions, & Content. Valid Roles are displayed in the pop-up list:

The Administrator User may change the First Name by selecting the First Name field. This will be used for display purposes in the application, and when sending or receiving invites. Changing the First Name will not only change it for future Events/Session/Media/etc., but will also change it for all past transactions/activity.

The Administrator User may also change the Last Name by selecting the Last Name field. This will be used for display purposes in the application, and when sending or receiving invites. Changing the Last Name will not only change it for future Events/Session/Media/etc., but will also change it for all past transactions/activity.

The Administrator User may change the mobile device phone number by selecting the Phone Number field. This will be used to send them invites when a text invite is chosen.

The Administrator User may change a User's status between “Active” and “Inactive” by toggling the selector in the Active field. If they make a User “Inactive”, they will no longer be able to be added to Events/Session/Media, nor will they be able to log into the application.

The Events list is a list of the Events to which the User has been made a Member, and is therefore associated. This means that they have been given access to the Event.

When the Administrator User has completed the changes they desire to the User's details, they may select the “Save” button, which will save these changes, and the User's Details for that User will be cleared.

If, at any point, the Administrator User decides not to “Save the changes they have made, they may click on a different function (either within the Administration function, or from the tabs at the top of the page) and their changes will not be saved.

### Group Administration

Users may be placed in, or removed from, Groups by selecting the Group Tab. A list of Groups will be displayed, and the Administrator User may select an existing Group, or choose to create a new Group. If an existing Group is selected, they will see a list of existing Users in that Group, and then be able to add or remove Users in the same way that Members and Participants lists work, as described below. If they decide to create a new Group, they will be allowed to enter the name of the new Group, and then edit the Group using the above functionality. Once created, Groups can be used in the same way Members and Participants are in the application, and can be added to Events, Sessions, or Media in order to give access to content (neither an Event, Session, nor Media may be ‘Owned’ by a Group).

### Company Administration

Company details is where certain information about the Administrator User's company can be entered and edited, such as the company name, address, logo, and Reference ID Label.

The Administrator User may enter a Company Name as they would like it to appear in the application. This will be used when a User (to which they have given permission) chooses the company to which content will belong in the Company assignment list. It will also be used when sending an invite to a guest user.

The Administrator User may enter the Reference ID Label they wish to use to identify Events. This will be used as a header (or label) for columns in lists of Events, all Users will be able to enter information that identifies these elements. Examples of Reference ID Labels include “Work Order Number”, “Claim Number”, “Job Number”, “Division”, “Client ID”, or “Classification”. In the case of “Division” for example, an organization can decide that it wants to identify all of its content by division, so the Users enter a division number or ID whenever creating a new Event, and that tag would be identified as the division number for that item. Likewise, an insurance company might desire to have a claim number associated with all Events, and therefore set the Reference ID Label to “Claim Number”. Each time an Event is created in the system, a claim number is entered in the Reference ID field, so that it can easily be found by the claim number.

The Administrator User must enter the first line of the company's address in the field named Company Address. This usually includes the address number and street. This is a required field.

The Administrator User may enter the second line of the company's address in the field named Company Address 2. This is usually used for something like the Suite number, PO Box, Mail Stop, or other distinguishing characteristics within a street address.

The Administrator User must enter the name of the City in which the company resides in the field named City.

The Administrator User must select the company's State from the drop-down list provided. The available states are dependent on the Country selected.

The Administrator User must enter the company's Zip Code in the field named Zip Code.

The Administrator User must select the company's Country from the drop-down list provided.

The Administrator User may upload a logo to be used to display within the application by selecting the “+Upload Company Logo” button. At this point the Administrator User may use their computer's “browse” capabilities to locate and upload a new logo, which will be displayed on the Company Administration page, and used throughout the application. The maximum number of pixels is 100×50.

The Administrator User may view the internal ID used by vMobile Collaborator to uniquely identify their company, but may not change this information.

The Administrator User must enter a first Name of their company's primary contact person in the field named Contact First Name.

The Administrator User must enter a last Name of their company's primary contact person in the field named Contact Last Name.

The Administrator User must enter the Email ID of their company's primary contact person in the field named Contact Email ID.

The Administrator User must enter the phone number of their company's primary contact person in the field named Contact Phone Number.

The Administrator User must enter the company's main phone number (usually the front desk) in the field named Company Main Phone Number.

The Administrator User may view the current status of the company by viewing the toggle used to indicate their company's status. The toggle will be set to “Active” if their current status is Active (using the system, or “Inactive” if their current status is inactive (not currently using the system)).

The Administrator User may enter a value in the minutes, hours, and/or days fields of the “PIN Expiration” section, which will indicate the amount of time from login that any company User may re-enter the application with only the use of their personal PIN before having to completely re-login to the application. If the Administrator User does not enter any value in any of these fields, the PIN number login will be disabled, and all Users must log in using their entire email ID and password every time they enter the application.

The Administrator User may also see the last date on which the company changed its Status from either ‘Active” to “Inactive” or from “Inactive” to “Active” by looking at the date in the Last Status Change Date field.

### Saved Tag Administration

As an Administrator User, the User may view the Saved Tags list, which is a list of predefined Tags saved in the system that will be used whenever they desire to Tag an Event/Session/Media and are using the “ALL” filter. The Saved Tags page also provides the Administrator User with a way to add new Tags to the list and to ‘Merge’ Tags (discussed below).

The Administrator User may select whether ‘non-Administrator’ Users may add Tags to the Saved Tags list. By checking the “Allow Users to Add Saved Tags” check-box, Users other than those with an Administrators role will be allowed to add new Tags to the Saved Tags list, otherwise only Administrator Users will be allowed to add new Tags to the Saved Tags list.

By selecting the “Add New Tag” button, the User may add new Tags that will appear on the list for all users of the system when they access the Tag list. A pop-up window appears, which allows them to add a new Tag. They type in the name of the Tag as they would like it to appear on the list, and click on the “Add New Tag” button. The system will not allow them to enter duplicate Tags.

By selecting multiple Tags from the list, and then clicking on the “Merge Tags” button which will display the “Merge Tags” pop-up window, the Administrator User may merge tags into a single Tag within the system. This is used when users have mistyped the name of Tags that they have entered manually, or if they decide to standardize on a single name for a Tag. For example, the User may have multiple tags in the system, such as (A/C, AC, Air Conditioner, Air Conditioning, Air Conditoning (misspelled), HVAC) and desire to eliminate the misspelled (fifth entry), and consolidate to one reference (“HVAC”) for all Air Conditioners in the system. The User selects all of the above from the list, and then clicks on the “Merge Tags” button. When the “Merge Tags” pop-up window appears, they select the tag they wish to keep (in this case, “HVAC”) from the list. This changes all references to the other Tags on the list to the “HVAC” Tag, and removes the other Tags from the list, so that they will no longer appear when the list is accessed.

### Associate Users

In order to better facilitate the use of the vMobile Collaborator applications, it is possible for an organization (company) to allow users (Members and Participants) to access Events, Sessions, Digital Content (Media), and metadata, as well as participate in Live Streaming (Collaboration) activities. To do this, the User may access the Associate Users functionality by selecting the “Associate Users” tab in the Administration portion of the web application. This will present the User with the Associate User List page, which shows a list of all Users from external companies that have been given access to the associating company's Events, Sessions, and Media. To add a new external user, the Administrator User may click on the “+” sign at the top right-hand corner of the page, which will display the Add Associated Users page. To select Company and User combinations to have access to their data, the Administrator User must first enter the Company ID of the company within which the external User belongs (in this way, the Company ID must be supplied to the associating company), and the User ID of the external User. This will cause a confirmation link to be sent to the invited external (Associated) User, as selected (by either email or text) by the Administrator User. Once the invited external User confirms the link, they will have the ability to Create Events and Sessions, Contribute Media (Digital Content), and view and modify any Event, Session, or Media to which the User has been given access. If an Administrator User desires to remove the access of an external (Associated) User, they may do so by clicking on the “x” to the right of the name on the Associated User List. This will remove their access to any existing Events, Sessions, or Media, but will NOT remove their name as associated with those same Events, Sessions, Media, so that if they are again associated, they will have access to all Events, Sessions, and Media again. Additionally, any Activity or Notes made when they were an Associated User will be maintained for audit purposes. As well, an Activity Log entry will be entered whenever an external User is added or removed.

### Using the Application

Before the User may begin using their vMobile Collaborator application (from either the web or mobile device), with full functionality, they must first be assigned a username (email address) and password. Once they have been assigned a username and password, they must enter them into the login page before access is granted to the application.

### Login

To login, the User must either enter the email Address that was used by the System Administrator when they were set up in the vMobile Collaborator system and their Password, their PIN, or use the biometric capability built into their computer.

### Email ID/Password

A valid email format is required in the email Address field (in the format of name@domain.type). The User must enter the password that they entered into the system when they first registered to use the application, or that they have chosen by changing it in the “Profile” section (using the “Password” tab). If they have forgotten their password, they may select the “Forgot your Password?” link in the bottom right-hand section of the login box, and a link will be sent to the user allowing them to create a new password.

### PIN

If the User has previously logged into the application using their Email ID and password, and they have not exceeded the time limit set by the Administrator User for the expiration of using a PIN, they may enter their PIN in the PIN field, and be logged directly into the application without having to re-enter their Email ID and Password. If they have exceeded the time limit, they will be required to enter their full Email ID and Password (see above) before being allowed to access the application

### Biometric Login

On a device that allows for Biometric input (fingerprint, retina scan, etc.), they User will be allowed to use their pre-defined Biometric recording to gain access to the application.

The User may select (check the box) “Remember Email ID”, and the application will save their email address, and automatically fill it in whenever they enter the Login page. This may be de-selected later, and the application will not fill in the email address.

After the User has entered their email address and Password, they click “Login”. Their credentials will be verified against those maintained in the system, and they will be given access to the application if they match. If no matching credentials are found in the system, an error message will be displayed, and they will be prompted to re-enter their credentials (email Address and Password).

### Email ID/Password

The User must enter the password that they entered into the system when they first registered to use the application, or that they have chosen by changing it in the “Profile” section

### Home Page

Once logged in to the application either the Events List, Sessions List, Media List, Settings screen, or Dashboard is displayed for the user, defined as the User's Home Page (modifiable on the Profile Page under My Home Page). Guests are logged into the system through a unique link mechanism that is described elsewhere in the “Add New Session—Participants” section. The user/guest is given the opportunity to select an Event or Session that already exists, or as a user (not a guest), to create a new Event/Session by pressing the “+” in the upper right-hand corner of the screen (if on the Event List, Session List, or Media List). If the user chooses to create a new Event, Session, or add Media, they are prompted to enter a name/title. If a new name or title is not entered, the Day, Date, and Time of creation will be used as the name for the Event or Session, or title of the Media.

### Events

Events are the main way something is identified or captured in the vMobile Collaborator application. An Event is typically used to document a happening in time. For example, a Property Management company might use an event to document an issue with a property (broken water pipe, fallen tree, damage to a wall, etc.), or an Insurance company might use an event to document an insured's claim (auto accident, fire, theft, etc.). An Event can also be something like the inspection of a property, or just the documentation of the condition of something like a structure, piece of equipment, vehicle, land, etc.

Within an Event, a User will enter details about the event (location, Tags, Media, Members, etc.). An Event may have Sessions (discussed later) associated with them.

### Events List

The User may see a list of all of the Events to which they have access by clicking on the “Events” tab at the top of the web application. This will display “ALL”, “Open”, or “Closed” Events, depending on the filter selected at the top of the list. The User may refine the list by typing in a search string in the “Search” field at the top of the page. Any Event that contains the “Search string” in any of the fields within the Event will appear on the list. If the User has been assigned the role of Administrator, they may also check the “Show All users Events” box at the top of the list to see all of the Events within their company, not just Events to which they have been associated (granted access by being added as a Member).

### Create a New Event

The User may create a new Event from the “Events List” page in the web application.

### Add New Event

To add a new event the User selects the “+Add New Event” button in the lower right-hand corner of the page. The “Add New Event” pop-up window appears, allowing them to enter Details, Location information, Tags, and Members to their newly created Event.

### Event Details

Event Details may be added, such as the Event Name, Event Description, and Reference ID (labeled by an Administrator, in this example “Project”).

The User may type in the name they would like displayed on the Event List (and used for searching) in the field named Event Name. This may be changed at any time, should they find it necessary. If no name is entered a default name of the date and time stamp is used for identification purposes.

The User may then type in the description they would like to use for this Event, which will be used to help them search for this Event (this is something that helps the User and others better understand the purpose of this Event) in the field named Event Description. This may be changed at any time, should they desire. If no Event Description is entered, this field is left blank.

The User may then type in a “Reference ID”. When originally setting up the system, the Administrator will have designated a name for this field (in this example, we have used “Project”), which will hold a significant identifier the User's company uses to identify their Events. Examples include things like (Customer Number, Work Order Number, Claim Number, Project, Incident ID, etc.).

The User may then type in the first line of the address associated with this Event. This is typically the street number and name.

The User may then type in the second line of the address associated with this Event. This is typically the unit number, apartment number, or suite number.

The User may then type in the City of the address associated with this Event.

The User may then select the State of the address associated with this Event from the dropdown list. This list is particular to the Country selected.

The User may then type in the Zip Code of the address associated with this Event.

The User may then select the Country of the address associated with this Event from the dropdown list.

### Add New Event—Members

Members of the User's organization and Associated Members may be given access to the User's new Event by selecting the Members tab, and then adding them to the list of valid Members. The User (or any Member who has been given access to this Event) may also add them in the future, if the User is not sure who should have access at this time, or if new members need access later. The User, as the Event ‘Owner’/‘Creator’ automatically has access to their newly created Event. To give additional Members access to the Event, the User may select the “Members” tab on the left side of the window. An “Inactive” member may not be granted access to an Event. A list of valid members and Associated Members will be displayed. If a Member is from an external company, it is indicated on the list by displaying their company name to the right of the Member's name. If the User would like, they can scroll down through the list, or they may begin typing in part of the name (first, last, or company) of a member they would like to add in the Search field, and the list will automatically search for any member with that string in his/her name/company. When the member the User would like to add is displayed on the list, they select them, and they will be given the option to ‘invite’ them with an email or text, or to add them without an ‘invite’. If the User selects to send them either an email or text, the native functionality of their computer will be used to generate the ‘invite’. If not, the Member will simply be added to the Event. If the User decides that they would like to remove a Member's access to the Event, they can click on the Member's name that has already been selected (check next to their name), and they will be removed.

### Add New Event—Tags

When the User creates a new Event, it is automatically tagged with Date, Time, GPS Location, and User (person that created it). In addition, the User may want to add additional Tags that help them identify significant things about the Event. This could include Tags about location (e.g. Inside, Outside, North, South, Basement, Elevator Room, etc.), the type of Event (e.g. Fire, Flood, Inspection, etc.), conditions (e.g. Cloudy, Rainy, etc.), or anything else that helps them (or any authorized User) find or organize Events in the future. If a Tag is added to an Event, there is no need to add the same Tag to a Session associated to that Event (see “Associate Sessions with Event” below), or to any Media added to an Event (see “Add Media to Event” below), as they will automatically be found through their association with the Event.

### Add—Tags

To add Tags to an Event the User may click in the Tags field. A list of valid Tags will display for the User. If they would like, they can scroll down through the list, or may begin typing in part of the name of a Tag they would like to add in the Search field, and the list will automatically search for any Tag with that string as part of the name. When the Tag they would like to add is displayed on the list, the User may select it, and it will be added to the Event. If the User decides that they would like to remove it from the Event, they can click on the Tag name, and it will be removed.

Once completed, the User selects the “Submit” button at the lower right corner to save the Event with all the new information. The User will then be taken to the Events List page, and the new Event will appear as the first entry on the list.

### Edit an Existing Event

Once the User has created the new Event, or if they have been given access to an Event someone else created, they will be able to edit the contents (or add Media) to the Event. By selecting the Event from the Event List page, the User will see the Event Overview page, which will allow them to edit various information about that Event (add or remove Media, Details, Location, Members, Tags, add Notes, Associate or remove Sessions, and view Activity).

### Event Details

Event Details may be edited in essentially the same way they were added above, with the exception that there is one added field which may be changed. This is the “Status” indicator for this Event. When an Event is created the “Status” indicator is set to “Open”, indicating that the Event is currently in use, and members may edit it, as well as add Media to it, or Associate Sessions with it. In the Event Details, the User may set the “Status” indicator to “Closed”, which will restrict access to this Event. While those who have been granted access as Members to the Event will still be able to view anything within the Event (including Media and Sessions), they will not be able to edit the Event or add new Members, Tags, and Media, or Associate Sessions. If an Event is in the “Closed” Status, only the Event's ‘Owner’/‘Creator’ or an Administrator can change it to “Open”.

### Sessions

Sessions are another way to organize information and collect Media. In addition, Sessions are the way multiple Users may collaborate using the Live Streaming function. Sessions may be associated with one or more Events, or may stand on their own (not be associated with an Event). Often times a Session is used to further categorize content within an Event. For example, a Property Management company might use a Session (or Sessions) within an Event to document the individual areas covered by a property inspection that has been set up as an Event. Therefore, the Event might be titled “123 Main St. Semi-annual Inspection”, and Sessions would be set up as “Fire System”, “Elevators”, “Accessibility”, and “Roof”. Access to the Sessions within an Event are done separately from the Event to which they are associated, therefore giving complete control over who has access to all content. Within a Session, a User will enter details about the Session (Tags, Media, Participants, etc.). A Session may be associated with one or more Events.

### Sessions List

The User may see a list of all of the Sessions to which they have access by clicking on the “Sessions” tab at the top of the web application. The User may display “ALL”, “Active”, or “Inactive” Sessions using the filters at the top of the list. The User may refine the list by typing in a search string in the “Search” field at the top of the page. Any Session that contains the “Search string” in any field will appear on the list. If the User is an “Administrator” they may also check the “Show All users Sessions” box at the top of the list to see the Sessions of all users in their company, not just Sessions to which they have been associated.

### Create a New Session

The User may create a new Session from the Sessions List page by clicking on the “+New Session” button at the bottom of the Session List. After selecting the “+New Session button, the “Create New Session” pop-up window will appear with a default name consisting of the current date and time used for the new Session name.

### Add New Session—Session Details

The User may click in the Session Name field in order to enter their own Session name. After entering the name, they may choose the “Secure” level for the Session. By default, the Session is created as “Unsecured” (the ‘Lock’ is open), which allows any authorized User to invite guests to the Session. If they desire, they may click on the “Secured” (the ‘Lock’ is closed), which means only users (Participants) with a valid email address and Password in the vMobile Collaborator system may be invited to participate in the Session. The User may then click on the “Create” button to save the new Session in the system.

### Add New Session—Participants

The User may add new Participants to the Session by clicking on the Participants tab. A Participants field will be displayed, allowing the User to begin typing in the name(s) of Participants. A filtered list of possible Participants will appear as the User types in each name. If the User clicks in this field a list of possible Users and Associated Users that may be added as Participants in this Session (If a Participant is added to the Session at the time of creation, no Invite will be sent to them. To send an Invite to the Participant, they must be added to the Session after the Session has been created.). If the User mistakenly adds a Participant to the Session and desires to remove them, they may click on the small “x” next to the Participants name. Once a Participant has been added, they will no longer appear on the pull-down list.

When the User has finished adding Participants to the Session, they may click on the “Submit” button in the bottom right-hand corner of the pop-up window. The new Session will be created, and the pop-up window will close, and the Session page will display the new Session, where they may edit information about the Session, add Media to the Session, or participate in a Live Stream.

### Edit an Existing Session

The User may edit many different characteristics about a Session, as well as add new users as Participants, Tags, and Media to the Session. Additionally, they may view what has been entered into a Session, or begin (or join) a Live Video Collaboration (Live Stream) from within the Session. To edit an existing Session, the User may select it from the Sessions List page, or (if it is associated with an Event) they may access it from within the Event.

### Edit Session—Details

To edit the Details of a Session the User clicks on the Details tab on the Session page, which will display the Details page for this Session. This allows them to change the Title of the Session, the Owner of the Session, the Active/Inactive Status, Secured/Unsecured Status, view all associated Events, and to add an Event to the Associated Events List.

To edit the Title of a Session the User may click in the Title field at the top of the page, at which time they can modify the Session name or click in the Title field, and then click on the small “x” within the field, which will clear the field.

To change the Owner of a Session, the User must be either the current Owner or have the rights of the Administrator role. They may click on the “Change Owner” button, which will open the “Change Owner” pop-up window, which will allow them to select any other current Participant from the list. This transfers ‘ownership’ to the new Owner.

To change the Status of the Session from “Active” to “Inactive”, or from “Inactive” to “Active” the User may click on the toggle switch to the right of the Active field. If a Session is “Active” and they make it “Inactive” the Session will be able to be viewed, but no other activity will be able to be performed on/within the session unless it is changed back to “Active” Status. Only the Session's Owner (the person who created it) or an Administrator can change a Session from “Inactive” to “Active”.

To change the Status of the Session from “Secured” to “Unsecured”, or from “Unsecured” to “Secured” the User may click on the toggle switch to the right of the Secured field. If a Session is “Secured” only Participants (from the User list) that are registered vMobile Collaborator users, with a user ID and password may be invited to participate in a Session. If the Session is “Unsecured” (“Secured” not set), then “Guest” Participants may be invited to participate in the Session (see below for this capability).

A list of all of the Events Associated with this Session is located at the bottom of the page. If the User would like to add another Event to the list of Associated Events, the User may click on the “Link an Existing Event” button on the top right of this list. When they do so, a page containing a scrolling list of all Events will display, and they may choose any number of Events from the list to Associate with this Session by checking the box next to the Event Name. When completed, the User clicks on the “Done” button in the upper right-hand corner of the pop up window. If they wish to remove an Event's Association with this Session, they may access the list of Associated Events by clicking on the “Link an Existing Event” button and selecting the Event from the list (already associated, indicated with a check mark before the name), and it will be removed from the list of Associated Events. When they have completed this, they may click on the “Done” button in the top right-hand corner, and the list will close, they will then be taken back to the Session Details page.

### Edit Session—Participants

To add or remove Participants or Groups to/from a Session the User may click on the Participants tab on the Session page, which will take them to the Participants page. This allows them to view the current Participants and Groups who have been invited to the Session, as well as add or remove Participants or Groups. To add additional Participants or Groups, the User Clicks on the “All” filter button, which will display a list of the valid Users and Groups and Associated Users who can be added to the Session as Participants. Associated Users are displayed with their company name to the right of their name. If they have already been added to the Session, there will be a check mark next to their name. To add another Participant or Group, the User may click on their name on the list, at which time a pop-up Invite window will appear. The User may choose to add them without an invite or send them an email or text Invite, or “Cancel” the addition of the Participant or Group. If they choose to “Invite” them by either email or text, they will be given the ability to add custom wording to an already existing invite message and link. If they select “email”, an email message will be generated with the invite and a link, which will take them either to the App Store to download the vMobile Collaborator application (on their mobile device) or the web application (if on their computer). The User may add a “Guest” to a Session by clicking on the “Add Guest” button. To remove a Participant or Group from the Session, click on the “Remove Participant” button, which will display a pop-up window which will allow them to select one or more Participants or Groups to remove from the Session (If they would like to remove the ‘Owner’ from the Session, the User must first change the ‘Owner’ to another Participant, and then use this method to remove them.). When they have finished removing Participants and Groups, they may click on the “X” button in the upper right-hand corner of the pop-up window. If the User wishes to add a Guest User to the Session, the User may click on the “+” sign in the upper right-hand corner of the screen, which displays the Invite Guest screen. From this screen, the User may enter one or more email addresses of Users they would like to invite as Guests to the Session, along with their first and last names, as well as an option as to how the User would like to invite the Guest (Email or Text). A screen will then appear containing either a text message template or an email template to complete, which is sent to the Guest. The Guest may then use the provided link within the email or text to access the Session on a one-time basis. For additional access, the Guest must be added as a registered User of the system.

### Edit Session—Media

The User may add or modify Media in a Session the same way that it is done in an Event (see above for details).

### Edit Session—Tags

Selecting the Tags tab on the Session page allows the User to view existing Tags for this Session, as well as add new Tags, create Tags that do not already exist on the pre-defined Tags list (if allowed by the Administrator), and remove existing Tags. When the User first enters the Tags page, the “Selected” filter will be engaged (if any Tags have been associated with this Session), showing all of the Tags currently associated with the Session. To see all Tags available on the pre-defined Tags list, and to add or remove Tags to/from this Session, the User may click on the “All” filter. This will show a list of all Tags on the pre-defined Tags list, with a check mark next to each Tag already associated with the Session. The User may add new Tags to the Session by selecting them from the “All” list, or by creating them by using the “New Tag” button. To remove an existing Tag, the User may either select a Tag on the “All” list that is already associated with the Session (indicated with a check mark), or click on the “Remove Tag” button, which displays a pop-up window with all associated Tags. They may then click on each of the Tags they wish to remove, and then click on the “X” in the upper right-hand corner of the pop up window to close this window, at which time they will be returned to the Session page.

### Edit Session—Activity

Clicking on the Activity tab on the Session page will take the User to the Activity page, which will provide them with a page containing all of the activities that have taken place for this Session. An activity is defined as an audit trail of all of the activity pertaining to the Session. The list is presented in descending chronological order, so that the last modification to the Session appears at the top of the list, and the creation (first ‘modification’) of the Session appears last. The User may select any item on the list, and they will see the details of the Activity. In addition, they may add Notes about the Session from this page.

### Edit Session Activity—Notes

While on the Activity page, the User may click in the notes field and type a note of any length about the Session (a Session may be associated with any number of Events, therefore the User needs to make sure their Notes are pertinent to the Session, no matter what Event(s) to which it is associated). Clicking on the check mark will cause the Note to be added, or clicking on the “X” will clear the Note without adding it.

### Live Stream

Once a Session has been created, and Participants invited to that Session, the User may use the Live Stream function to collaborate using real-time video and duplex-audio with one or more of the Participants of the Session, as well as invite additional Participants to the Live Stream. To launch a Live Stream the User Clicks on the Live Stream window on the right-hand side of the Session Overview page. This places the User in the Live Stream Waiting Room, where they are connected by duplex-audio to all other Participants of the Live Stream. The User may choose to mute their audio or take Notes at this point. If the User is the first in the Live Stream Session, they become the Moderator, which gives them the ability to assign publishing rights and change Moderators. The User is presented with several buttons to control the use of Audio, take Notes, and Invite existing Participants to the Live Stream Session, as well as access the Group functions within Live Stream.

### Group

Pressing on the Group icon takes the User to the Group screen, which shows the User all of the Participants currently associated with the Session, All of the User's contacts (within the company), and the controls to change Publishers, Moderator, and Invite additional Participants to the Session.

### Session Participants—In a Live Stream

Within the Group screen, the User may view who is the current Moderator of the Live Stream session, view who is the current Publisher of the Live Stream session, Send an Email and/or text reminder to another Participant, and if they are the Moderator, change to a new Moderator or Publisher, and Remind a Session Participant of the fact that a Live Stream session is occurring.

vMobile Contacts—In a Live Stream

Within the Group screen, the User may view all of the other Users, and invite them to participate in the Session, as well as invite a Guest to participate in the Live Stream.

When the User is done using the Group functions, they may press on the “x” in the upper right-hand corner to close this screen.

When in a Live Stream, indicator buttons change color to depict who is participating in the Live Stream session, who has indicated that they wish to be the Publisher, who the current Moderator is, and who is currently publishing. Additionally, if the User is invited to be the new Moderator, they will receive a pop-up message window, which will allow them to accept or decline the invitation.

If the Publisher chooses to Record the Live Stream, it will be saved to the Session, and available to any Session Participant to view from the Media section of the Session. Each time the Publisher presses on the Record button to capture or stop capturing the Live Stream, the current recording is stopped, and a new recording is started.

While in a Live Stream session, any image that has been captured by the Publisher will be displayed as a thumbnail in the Media viewer panel at the top of the page, and may be expanded to full screen size by the User. It may again be reduced to a thumbnail by clicking on the “x” in the upper right-hand corner. The thumbnails may be scrolled up or down by using the slider tab next to the list of thumbnails. To exit the Live Stream session, the User may click on the Exit button, and they will be prompted to confirm their desire to exit the Live Stream session before they are taken back to the Session Overview screen.

### Media Capture

As mentioned previously, Media (digital content) may be uploaded and associated to any Event or Session to which a user has access. In addition, Media may be uploaded to the vMobile Collaborator Media Roll without being associated (or attached) to any Event or Session. This is done by accessing the Media List (by clicking on the Media tab on the top of any page).

### Media List

Once the user has accessed the Media List, they will see a list (with small thumbnail views) of each piece of media to which they have access (all media, if they are an Administrator, and they have selected to “Show all Media” by checking the box at the top of the list). To view any individual Media item, they may simply click anywhere on the line for that piece of Media, and the Media Details page will be displayed. They may also add additional Media to the Media Roll by clicking the “+” (plus sign) in the upper right-hand corner of the page. The user will then be presented with the browser window, which allows them to find Media (using the computer's native functionality), which allows them to search for the media they desire to upload. Additionally, they may add a Title to the Media, give Members and Groups access or remove access to/from the Media, Link it to an Event or Session, add or remove Tags to/from the Media, view any Activity associated with the Media (including Notes). Members, Tags, and Activity work in the same manner as previously described in the Events function. To Link Media to an Event or Session, the user will click on the Link button on the Media Details page, and then select either Event or Session from the list on the Media Link page (they may click “Cancel” to exit without linking the Media to any Event or Session). If the user has selected to Link to an Event, a new page will appear with a list of Events to which the user has access, and they will be given the opportunity to select one or more Events from the list to which the Media will be associated (Linked). If they selected Session, then the list will contain Sessions to which they have access, and they may associate (Link) the Media with one or more Sessions from the list. After selecting the Events or Sessions which the user would like to associate the Media, they click on the “Close” button at the bottom of the page to return to the Media List page.

### Profile

As an individual User of the vMobile Collaborator system (regardless of the Users role) any User may make changes to their personal Profile, including changing their contact information, password, PIN, and default Home Page.

### Contact Information

Once in the Profile section, the User may change their contact information by selecting the Profile Tab on the left-hand side of the page. The User may view their Role and current Status (“Active” or “Inactive”. However, if they are “Inactive” they will not be able to access this page or the application), First Name, Last Name, Phone Number, Email Address, and Physical Address. When complete, the User may clicking on the Save button to save their changes.

### Password

Pressing on the Password Tab on the left-hand side of the page allows the User to change their Password, which is verified, and requires that they adhere to the Password strength policy within the application. The User may also change their personal PIN on this page. When finished, the User may save these changes by clicking on the Save button at the bottom of the page. After their password has been changed, the User will be taken back to the login page, where they are required to re-login to the application with their new Password.

### My Home Page

The User may click on the My Home Page Tab on the left-hand side of the page to access the page allowing them to set their default Home Page when logging into the vMobile Collaborator system. A list of available pages is displayed to the User, with their current default Home Page as the highlighted choice. From the list, the User may select which page is displayed to them after successful login to the system.

### Dashboard

The User may access their personalized dashboard by clicking on the Dashboard Tab at the top of any page, which displays the User's specific combination of information which is most important to them (as defined by each User in the Profile section of the application).

vMIC (vMobile Instant Communicator)

By using the vMIC (vMobile Instant Communicator) function within the application, and accessible from the Profile page, the User may notify other Users that they are available for Instant Communications, or initiate an Instant Communicator session with one or more other Users who have indicated that they are available. To indicate that a User is available for Instant Communications, the User clicks on the Available button within the vMIC screen, which is then viewable to all other Users within their company. If a User logs off of the application, or closes their web browser, they instantly become unavailable. If a User is in the Available mode, and another User attempts to use Instant Communicator with them, a tone sounds in the application, and a notification window appears. Clicking on the vMIC button in the pop-up window takes them to the vMIC screen, and they are presented with an option to accept or reject the Instant Communication. If they accept, a TALK button appears, which activates the microphone on their device to talk to the other party or parties in the Instant Communicator session. When they stop click to stop talking, they are in listen mode, and they can hear other parties in the session when they are talking At any time, the User may remove themselves from the Instant Communicator session by clicking on the Disconnect button. If a User would like to initiate an Instant Communicator session, they click on the Instant Communicator button, and a list of available Users is presented to them. At this time, they select the User or Users that they would like to communicate with from the list, and click on the Initiate button to start the Instant Communicator session. Once the first User on the list of selected Users accepts the invitation, the Instant Communicator session begins. When only one User is left in the session, the session ends.

### Mobile Application

The Mobile application allows a User to do essentially the same functions as the Web application, with the following exceptions. 1) Administration cannot be done in the Mobile application, 2) Content may only be captured (video, audio, images) in the Mobile application, while uploading of said content may only be done in the Web application, 3) Only Users on the Mobile application may be assigned publishing rights in a Live Stream.

### Login

To login, the User must either enter the email Address that was used by the System Administrator when they were set up in the vMobile Collaborator system and their Password, their PIN, or use the biometric capability built into their computer.

### Email ID/Password

A valid email format is required in the email Address field (in the format of name@domain.type). The User must enter the password that they entered into the system when they first registered to use the application, or that they have chosen by changing it in the “Profile” section (using the “Password” tab). If they have forgotten their password, they may select the “Forgot your Password?” link in the bottom right-hand section of the login box, and a link will be sent to the user allowing them to create a new password.

### PIN

If the User has previously logged into the application using their Email ID and password, and they have not exceeded the time limit set by the Administrator User for the expiration of using a PIN, they may enter their PIN in the PIN field, and be logged directly into the application without having to re-enter their Email ID and Password. If they have exceeded the time limit, they will be required to enter their full Email ID and Password (see above) before being allowed to access the application.

### Biometric Login

On a device that allows for Biometric input (fingerprint, retina scan, etc.), they User will be allowed to use their pre-defined Biometric recording to gain access to the application.

If the User has forgotten their password, they may select the “Forgot your Password?” link in the bottom right-hand section of the login box, and a link will be emailed to the user's registered email address, which will allow them to change it to a new password. Before pressing the “Login” button at the bottom of the screen, the user may press on the “Remember email” slider and the application will save their email address, and automatically fill it in each time they enter the Login screen. This may be de-selected later, and the application will not fill in their email address. After entering their email address and password, the user selects the “Login” button, which then causes the application and backend processes to validate their credentials against those maintained in the system, and gives them access to the application if they match. If no matching credentials are found in the system, an error message will be displayed, and they will be prompted to re-enter their credentials (email Address and Password). If the user would like to get more information about the application or the company they may press on the “About vMobile” link at the bottom of the Login screen, which will take them to the “About” page on our corporate web site, where they can learn more about company, applications & services. Pressing the “Close About” button at the bottom of the page will return them to the Login page. Additionally, the current vMobile Collaborator application release number is displayed below the Login button on the screen.

### Home Page

Once logged in to the application either the Events List, Sessions List, Media List, Settings screen, or Dashboard is displayed for the user, defined as the User's Home Page (modifiable on the Settings Screen). Guests are logged into the system through a unique link mechanism that is described elsewhere in the “Add New Session—Participants” section. The user/guest is given the opportunity to select an Event or Session that already exists, or as a user (not a guest), to create a new Event/Session by pressing the “+” in the upper right-hand corner of the screen (if on the Event List, Session List, or Media List). If the user chooses to create a new Event, Session, or add Media, they are prompted to enter a name/title. If a new name or title is not entered, the Day, Date, and Time of creation will be used as the name for the Event or Session, or title of the Media.

### Events

Events are the main way something is identified or captured in the application. An event is typically used to document a happening in time. For example, a Property Management company might use an event to document an issue with a property (broken water pipe, fallen tree, damage to a wall, etc.), or an Insurance company might use an event to document an insured's claim (auto accident, fire, theft, etc.). An Event can also be something like the inspection of a property, or just the documentation of the condition of something like a structure, piece of equipment, vehicle, land, etc. Within an Event, they will enter details about the event (location, Tags, Media, Notes, Members, etc.). An Event may also have one or more Sessions (described later) associated with it.

### Event Details

After either creating a new Event or pressing on the Event the user wishes to edit in the Event List, the Event Details screen is displayed. At this point the user may change the name they would like displayed on the Event List (and used for searching) by tapping on it in the Event Details screen. This may be changed at any time, as long as the Event is “Open” (described below). The user may then change the description of this Event, which will be used to search for this Event (this is something that helps the user better understand the purpose of this Event) they may press in the field named Description and modify or enter the description. This may be changed at any time, as long as the Event is “Open” (described below). The user may change the “Reference ID” value in the field just below the Description. The title of this field is defined by an Administrator (described above) when the system is set up (“Project” for this example). Other examples include things like (Customer Number, Work Order Number, Claim Number, Project, Incident ID, etc.). The user may change the “Status” of the Event either from “Open” to “Closed” or from “Closed” to “Open”, which affects the ability to make changes to the Event and on which list it appears in the Event List. Only the ‘Owner’ of the Event (or an Administrator) may change the Event's Status. To enter the Event's location, the user may use the GPS locator to assist them by using the native GPS device within their mobile device. Pressing on the blue locator pin on the Event Details screen a physical address is generated using reverse-geocoding, which the user may select or reject. If selected, the address will be populated in the address fields, and then modified as desired. If rejected, the user may enter their own address manually.

To add or change the first line of the address associated with this Event, the user may press in the “Address Line 1” field and modify or type in the first line of the address. This is typically the street number and name. To add or change the second line of the address associated with this Event, the user may press in the “Address Line 2” field and modify or type in the second line of the address. This is typically the unit number apartment number, or suite number. To add or change the city for this Event, the user may press in the “City” field and modify or type in the name of the city. To add or change the state for this Event, the user may select a State from the drop-down list of valid states (which is specific to the country selected). To add or change the Zip Code of the address associated with this Event, the user may press in the Zip Code field to enter or modify the Zip Code. To add or change the County of the address associated with this Event, the user may use the drop-down list of countries and select a valid country.

### Event Members

The User may also press on the Members line in the Event Overview screen, which will take them to the Members screen, where they can add new Members or Groups to the Event, or remove existing Members or Groups from the Event. When the Members screen is displayed, the “Selected” filter will be engaged, showing the User the Members who have already been given access to this Event. The User may change the view to see all Users and Associated Users eligible to be added to this Event by selecting the “All” filter. When the “All” filter is engaged, Members and Groups who have already been added to the Event will be indicated with a checked mark after their name. Associated Users are displayed with their company name to the right of their name. If the User knows part of the name of a member or Group they wish to see, they may begin typing part of the name in the “Search” field at the top of the screen, and only Members and Groups with the string they typed will appear on the list. If a Member or Group has already been added to this Event, selecting their name will remove them from the Event, otherwise selecting their name will add them to the Event.

### Event Media

If the user desires to view/modify existing media, delete media, or to add media to the Event, pressing the Media line on the Event Overview screen will take them to the Media screen, which will provide them with a screen containing all of the media associated with this Event. The media screen allows a user to view existing media already associated with the Event, add new media, delete media, change the title of media, or add/remove Tags associated with the media. They may also search for media using the “Search” field at the top of the screen (search works on the title of the Media).

To add new media to an Event, the user may press the “+” button in the upper right-hand corner of the screen. This will display Media Overview screen, which will allow them to choose a Title for the Media they are about to add, as well as add any Tags they would like to have associated with this Media. Once done, they may select the camera icon in the upper right-hand corner of the screen to access their mobile device's native camera, and begin capturing the Media. After completing the Media Capture, they may press the Done button, and will then be returned to the Media Overview screen. Media may be added in two ways, 1) Capture the Media, 2) Use existing Media on their mobile device. If the user wishes to delete media from an Event, first they select the media they wish to delete. The Media Details screen with the Title, Date Created, a place to Add/Remove Tags, and a small version of the media (or icon, if not a photo), and a “Delete Media” button at the bottom of the screen will be displayed. They may then press on the “Delete Media” button, which will cause the “Delete Media” pop-up window to appear. They may then select “YES” to delete the media, or “NO” to return to the Media Details screen, without the media being deleted. If the user wishes to change the title of the media, they first select the media they wish to change. The Media Details screen with the Title, Date Created, a place to Add/Remove Tags, and a small version of the media (or icon, if not a photo), and a “Delete Media” button at the bottom of the screen will be displayed. They may then press on the Title of the media, and modify it as desired. When completed, they press on the “Back” button in the upper left-hand corner of the screen to return to the Media screen.

To view Tags, add new Tags, or remove existing Tags, associated with Media, the user must first select the media desired. The Media Details screen with the Title, Date Created, a place to Add/Remove Tags, and a small version of the media (or icon, if not a photo), and a “Delete Media” button at the bottom of the screen will be displayed. The user may then press on the “Tags” line, which will display the Tags screen, with the “Selected” filter engaged. They may add new Tags to the media by selecting them from the “All” list, or by creating them by using the “+” button in the upper right-hand corner. To remove an existing Tag, the user may select it from the list of already selected Tags. When completed, they press on the “Back” button in the upper left-hand corner of the screen, which returns them to the Media Details screen.

### Event Tags

To view Tags, add new Tags, or remove existing Tags associated with the Event, the user may press on the Tags line on the Event Overview screen, which will take them to the Tags screen, where they may add new Tags to the Event, or remove existing Tags from the Event.

When the user first selects the Tags line, the “Selected” filter will be engaged, showing them all of the Tags associated with the Event. They may see all of the Tags on their company's pre-defined Tag list by selecting the “All” filter at the top of the screen. When the “All” filter is engaged, Tags already associated with the Event have a check mark in front of them. To select another Tag from this list, the user may press the name of the Tag they wish to add. To remove a Tag, the user presses on the name of a Tag already selected (with the “All” filter engaged). If allowed, and they wish to create a new Tag (one not already on the list of pre-defined Tags), they may do so by pressing on the “+” icon in the upper right-hand corner of the screen. They are then presented with a pop-up window allowing them to create the new Tag. After they have typed in the name of the new Tag they wish to create (if it does not already exist), it will be created and added to this Event. The application will not allow a user to create a duplicate Tag of one already on the pre-defined list.

### Event Sessions

Pressing on the Sessions line on the Event Overview screen will take the user to the Sessions screen, which will provide them with a screen containing all of the Sessions associated with this Event to which they have access (are a named participant, unless they are an Administrator). From here they may add a new Session to an Event (either an already existing Session, or one they create here), and modify anything in a Session (described below).

### Event Activity

Pressing on the Activity line on the Event Overview screen will take the user to the Activities screen, which will provide the user with a screen containing all of the “Activities” that have taken place for this Event. An Activity is defined as an audit trail of all of the activity pertaining to the Event. The list is presented in descending chronological order, so that the last modification to the Event appears at the top of the list, and the creation (first ‘modification’) of the Event appears last. The user may select any item on the list, and will see the details of the Activity. In addition, they may add Notes about the Event from this screen. While in the Activity screen, the user may press on the “+” button in the upper right-hand corner to add a Note about this Event. Pressing on the “+” icon will cause the “Add Note” pop-up window to appear. The user may then type a note of any length in the text box provided in order to add it to the Event. When they have completed entering their Note, they may press on the “Add” button to save their note, or the “Cancel” button to discard their Note without saving it.

### Sessions

Sessions are another way to organize information about something that either takes place or needs to be saved, accessed, or viewed in a central location. A Session may be associated with one or more Events, or may stand alone. Additionally, a Session is the way multiple users and guests may collaborate in a live audio/video conference and share content.

### Sessions List

A user may see a list of all of the Sessions to which the user has access by viewing the Sessions List screen. To view this screen the user presses on the “Sessions” icon in the vMCC or by logging into the application with “Session” chosen as their Home Page in the Settings section of the vMCC. They may display “ALL”, “Active”, or “Inactive” Sessions using the filters at the top of the list. They may refine the list by typing in a search string in the “Search” field at the top of the screen. Any Session that contains the “Search string” in the Name (described below) will appear on the list. If they are an “Administrator” they may also check the “Show All users” box in the Settings screen on the vMCC.

### New Session

To add a new Session, the user presses the “+” button at the top of the Session List in the upper right-hand corner of the screen. After selecting the “+” (Add New Session) button, a pop-up window will appear with a default Title consisting of the date and time used for the new Session Title. At this time the user may enter their own Title by pressing the small “x” on the right side of the input field. After entering the Title and selecting “Add” on the pop-up window, the new Session will be created and saved to the cloud (as long as they are connected to a network, including a mobile network. If they are not connected, it will be saved to the local database, and uploaded when a connection is available—described below).

### Edit Session

Once saved, a new screen will appear, which allows the User to edit the characteristics about the Session (described below). To edit the different characteristics about a Session, as well as add new Participants, Tags, Notes, and Media to the Session, or to begin (or join) a Live Video Collaboration from within the Session, the user first enters the Session by accessing an existing Session from the Session List (or Event/Session List), or by having created it, as described above. Once they have accessed the desired Session and are in the Session screen, they may edit Details, Participants, Media, Notes, or Tags, as well as view Activity and use the Live Video Collaboration capabilities.

### Edit Session Details

To edit the Details of a Session, the user presses on the Details line in the Session Screen, which will display the Details screen for this Session. This allows them to change the Title of the Session, the Active/Inactive Status, the Secured/Unsecured Status, view all associated Events, and to associate this Session with any number of existing Events (by adding an Event to the Associated Events List). To edit the Title of a Session, the user presses in the Title field at the top of the screen or on the small “x” within the field. They may then edit the Title or enter a new Title for this Session. To change the Status of the Session from “Active” to “Inactive”, or from “Inactive” to “Active” the user presses on the check mark to the right of the Active field (a Session is “Active” if the check mark is blue, and “Inactive” if the check mark is grey). If a Session is “Active” and they make it “Inactive” the Session will be able to be viewed, but no other activity will be able to be performed on/within the session unless it is changed back to “Active” Status. Only the Session's Owner (the person who created it) or an Administrator can change a Session from “Inactive” to “Active”. To change the Status of the Session from “Secured” to “Unsecured”, or from “Unsecured” to “Secured” the user may press on the check mark to the right of the Secured field (a Session is “Secured” if the check mark is blue, and “Unsecured” if the check mark is grey). If a Session is “Secured” only Participants (from the Participant list) that are registered users, with a user ID and password may be invited to participate in a Session. If the Session is “Unsecured” (“Secured” not set), then “Guest” Participants may be invited to participate in the Session (described further below). A list of all of the Events Associated with this Session is located at the bottom of the screen. If the user would like to add another Event to the list of Associated Events, they may press the “+” button on the top right of this list. When they do so, a screen containing a scrolling list of all Events will display, and they may choose any number of Events from the list to Associate with this Session. If they wish to remove an Event's Association with this Session, they may also select an already highlighted Event on the list, and it will be removed from the list of Associated Events. When they have completed this, they may press on the “Done” button in the top right-hand corner, and the list will close, they will then be taken back to the Session Details screen. Add New Session—Participants

### Add New Session—Participants

The User may also press on the Participants line in the Session Overview screen, which will take them to the Participants screen, where they can add new Participants or Groups to the Session, or remove existing Participants or Groups from the Session. When the Participants screen is displayed, the “Selected” filter will be engaged, showing the User the Participants who have already been given access to this Session. The User may change the view to see all users and Associated users eligible to be added to this Session by selecting the “All” filter. When the “All” filter is engaged, Participants who have already been added to the Session will be indicated with a checked mark after their name. Associated Users are displayed with their company name to the right of their name. If the User knows part of the name of a Participant or Group they wish to see, they may begin typing part of the name in the “Search” field at the top of the screen, and only Participants or Groups with the string they typed will appear on the list. If a Participant or Group has already been added to this Session, selecting their name will remove them from the Session, otherwise selecting their name will add them to the Session. If the User wishes to add a Guest User to the Session, the User may press on the “+” sign in the upper right-hand corner of the screen, which displays the Invite Guest screen. From this screen, the User may enter one or more email addresses of users they would like to invite as Guests to the Session, along with their first and last names, as well as an option as to how the User would like to invite the Guest (Email or Text). A screen will then appear containing either a text message template or an email template to complete, which is sent to the Guest. The Guest may then use the provided link within the email or text to access the Session on a one-time basis. For additional access, the Guest must be added as a registered User of the system.

### Session Media

If the user desires to view/modify existing media, delete media, or to add media to the Session, pressing the Media line on the Session Overview screen will take them to the Media screen, which will provide them with a screen containing all of the media associated with this Session. The media screen allows a user to view existing media already associated with the Session, add new media, delete media, change the title of media, or add/remove Tags associated with the media. They may also search for media using the “Search” field at the top of the screen (search works on the title of the Media).

To add new media to n Session, the user may press the “+” button in the upper right-hand corner of the screen. This will display Media Overview screen, which will allow them to choose a Title for the Media they are about to add, as well as add any Tags they would like to have associated with this Media. Once done, they may select the camera icon in the upper right-hand corner of the screen to access their mobile device's native camera, and begin capturing the Media. After completing the Media Capture, they may press the Done button, and will then be returned to the Media Overview screen. Media may be added in two ways, 1) Capture the Media, 2) Use existing Media on their mobile device. If the user wishes to delete media from a Session, first they select the media they wish to delete. The Media Details screen with the Title, Date Created, a place to Add/Remove Tags, and a small version of the media (or icon, if not a photo), and a “Delete Media” button at the bottom of the screen will be displayed. They may then press on the “Delete Media” button, which will cause the “Delete Media” pop-up window to appear. They may then select “YES” to delete the media, or “NO” to return to the Media Details screen, without the media being deleted. If the user wishes to change the title of the media, they first select the media they wish to change. The Media Details screen with the Title, Date Created, a place to Add/Remove Tags, and a small version of the media (or icon, if not a photo), and a “Delete Media” button at the bottom of the screen will be displayed. They may then press on the Title of the media, and modify it as desired. When completed, they press on the “Back” button in the upper left-hand corner of the screen to return to the Media screen.

To view Tags, add new Tags, or remove existing Tags, associated with Media, the User must first select the media desired. The Media Details screen with the Title, Date Created, a place to Add/Remove Tags, and a small version of the media (or icon, if not a photo), and a “Delete Media” button at the bottom of the screen will be displayed. The user may then press on the “Tags” line, which will display the Tags screen, with the “Selected” filter engaged. They may add new Tags to the media by selecting them from the “All” list, or by creating them by using the “+” button in the upper right-hand corner. To remove an existing Tag, the user may select it from the list of already selected Tags. When completed, they press on the “Back” button in the upper left-hand corner of the screen, which returns them to the Media Details screen.

### Edit Session Tags

Selecting the Tags line on the Session screen allows the User to view existing Tags for this Session, as well as add new Tags, create Tags that do not already exist on the pre-defined Tags list (if allowed), and remove existing Tags. When the User first enters the Tags screen, the “Selected” filter will be engaged (if any Tags have been associated with this Session), showing all of the Tags currently associated with the Session. To see all Tags available on the predefined Tags list, and to add or remove Tags to/from this Session, the User may press on the “All” filter. This will show a list of all Tags on the pre-defined Tags list, with a check mark next to each Tag already associated with the Session. The User may add new Tags to the Session by selecting them from the “All” list, or by creating them by using the “+” button in the upper right-hand corner. To remove an existing Tag, the User selects a Tag on the “All” list that is already associated with the Session (indicated with a check mark). When completed, the User presses on the “Back” button in the upper left-hand corner of the screen to return to the Session screen.

### Edit Session Activity

The user may press the Activity line on the Session screen, which will take them to the Activity screen, and provide them with a page containing all of the activities that have taken place for this Session. An activity is defined as an audit trail of all of the activity pertaining to the Session. The list is presented in descending chronological order, so the last modification to the Session appears at the top of the list, and the creation (first ‘modification’) to the Session appears last. The user may select any item on the list, and they will see the details of the Activity.

### Edit Session Notes

In addition, the User may add Notes about the Session from this screen. While in the Activity screen, the User may press the “+” button in the upper right-hand corner to add a Note about this Session. Pressing on the “+” icon will cause the “Add Note” pop-up window to appear. The User may then type a note of any length in the text box provided in order to add it to the Session (A Session may be associated with any number of Events, so they must make sure their Notes are pertinent to the Session, no matter what Event(s) to which it may be associated). When they have completed entering their Note, the User presses on the “Add” button to save their note, or on the “Cancel” button to discard their Note without saving it.

### Live Stream

Once a Session has been created, and Participants invited to that Session, the user may use the Live Stream function to collaborate using real-time video and duplex-audio with one or more of the Participants of the Session, as well as invite additional Participants to the Live Stream. To launch a Live Stream the User taps on the Live Stream line in the Session Overview screen. This places the User in the Live Stream Waiting Room, where they are connected by duplex-audio to all other Participants of the Live Stream. The User may choose to mute their audio or take Notes at this point. If the User is the first in the Live Stream Session, they become the Moderator, which gives them the ability to assign publishing rights and change Moderators. The User is presented with several buttons on the bottom of the screen to control the use of video, Audio, Photos, and Notes, as well as an icon in the upper right-hand corner to access the Group functions within Live Stream.

### Group

Pressing on the Group icon takes the User to the Group screen, which shows the User all of the Participants currently associated with the Session, All of the User's contacts (within the company), and the controls to change Publishers, Moderator, and Invite additional Participants to the Session.

### Session Participants—In a Live Stream

Within the Group screen, the User may view who is the current Moderator of the Live Stream session, view who is the current Publisher of the Live Stream session, Send an Email and/or text reminder to another Participant, and if they are the Moderator, change to a new Moderator or Publisher, and Remind a Session Participant of the fact that a Live Stream session is occurring.

vMobile Contacts—In a Live Stream

Within the Group screen, the User may view all of the other Users, and invite them to participate in the Session, as well as invite a Guest to participate in the Live Stream.

When the User is done using the Group functions, they may press on the “x” in the upper right-hand corner to close this screen.

When in a Live Stream, message windows appear at the top of the User's screen indicating the name of the current Moderator and Publisher, as well as other actions, such as Recording status. Additionally, if the User is invited to be the new Moderator or Publisher, they will receive a pop-up message window, which will allow them to accept or decline the invitation. While participating as the Publisher, a User will have additional capabilities, which include the ability to Pause the publishing of their camera's video, Record the Live Stream, and capturing images from the video stream they are publishing. If they capture an image while publishing, the image will be saved to the Session, and available for all Participants to see, both while in the Live Stream, or in the Media section of the Session.

If the Publisher chooses to Record the Live Stream, it will be saved to the Session, and available to any Session Participant to view from the Media section of the Session. Each time the Publisher presses on the Record button to capture or stop capturing the Live Stream, the current recording is stopped, and a new recording is started. The Publisher may also press on the light icon, and the light on their mobile device will activate (or deactivate, if already activated).

While in a Live Stream session, any image that has been captured by the Publisher will be displayed as an opaque thumbnail down the right side of the viewing screen, and may be expanded to full screen size by the User. It may again be reduced to an opaque thumbnail by pressing on the “x” in the upper right-hand corner. The thumbnails may be scrolled up or down by using the slider tab next to the list of thumbnails. To exit the Live Stream session, the User may press on the Back (“<”) icon in the upper left-hand corner of the screen, and they will be prompted to confirm their desire to exit the Live Stream session before they are taken back to the Session Overview screen.

### Media Capture

As mentioned previously, Media (digital content) may be captured or uploaded and associated to any Event or Session to which a user has access. In addition, Media may be captured or uploaded to the vMobile Collaborator Media Roll without being associated (or attached) to any Event or Session. This is done by accessing the Media List (either from the vMCC, described elsewhere, or directly upon login, if the Media List is the users default Homepage, also described elsewhere). Once the user has accessed the Media List, they will see a list (with small thumbnail views) of each piece of media to which they have access (all media, if they are an Administrator, and they have “Show all users” selected in their Settings (described elsewhere). To view any individual Media item, they may simply press anywhere on the line for that piece of Media, and the Media Details screen will be displayed. They may also add additional Media to the Media Roll by pressing the “+” (plus sign) in the upper right-hand corner of the screen. The user will then be presented with the Media Capture screen, which allows them to either immediately begin capturing Media (by pressing on the camera icon in the upper right-hand corner of the screen), which will launch the native camera of their mobile device (described elsewhere), or add a Title to the Media, give Members or Groups access or remove access to/from the Media, Link it to an Event or Session, add or remove Tags to/from the Media, view any Activity associated with the Media (including Notes), or view all of the Media captured during this ‘Media Capture’ session. Members, Tags, and Activity work in the same manner as previously described in the Events function. To Link Media to an Event or Session, the user will press on the Link line in the Media Capture screen, and then select either Event or Session from the list in the Media Link screen (they may press “Cancel” to exit without Linking the Media to any Event or Session). If the user has selected to Link to an Event, a new screen will appear with a list of Events to which the user has access, and they will be given the opportunity to select one or more Events from the list to which the Media will be associated (Linked). If they selected Session, then the list will contain Sessions to which they have access, and they may associate (Link) the Media with one or more Sessions from the list. After selecting the Events or Sessions which the user would like to associate the Media, they press on the “Close” button at the bottom of the screen to return to the Media List screen.

vMCC (vMobile Control Center)

From any entry screen within the vMobile Collaborator application, the user may press on the Visual Mobile logo (in blue) at the bottom of the screen, and a slide-up menu called the vMobile Control Center (vMCC), which contains a set of menu options which will help them navigate around the application, and perform specialized functions that help with the use of the application.

### Session Icon

Pressing on the Session icon in the vMCC takes the user to the Session List screen (described above).

### Events Icon

Pressing on the Events icon in the vMCC takes the user to the Events List screen (described above).

### Media Icon

Pressing on the Media icon in the vMCC takes the user to the Media List screen (described above).

vMIC (vMobile Instant Communicator) Icon

Pressing on the vMIC icon in the vMCC takes the user to the vMobile Instant Communicator screen (described below).

### Dashboard Icon

Pressing on the Dashboard icon in the vMCC takes the user to the Dashboard screen (described below).

### Help Icon

When the User presses on the Help icon a screen is opened with the vMobile Collaborator User manual, which allows them to search for help on the subject about which they are interested. When finished, they may press on the “Close Help” button to return to the screen they were on before they invoked the vMCC.

### Share Icon

To share the vMobile Collaborator application with another person, the user may press on the “Share” icon, which will cause a pop-up window which allows them to choose the way to invite others to join their company as a vMobile Collaborator user. A new user may be invited by either sending them a text “Message” or an “email”. Before they may use the system (after either downloading the application to their mobile device, or by accessing the web application), they will need to be set up as a Member in the Administration section of the web application (described elsewhere) or added as an Associated User (also described elsewhere). By pressing the “Cancel” in the pop-up window the user will exit without sharing the application. When completed, they will be returned to the screen they were on before they invoked the vMCC.

### Settings Icon

The user may press on the Settings icon to access the Settings available within the mobile application. Within the Settings page, the user may select the company on behalf of which they would like to work by pressing in the “You are currently working on work assigned by:” field. A slide-up screen with a list of companies on which they may work appears. They may then select a company from this list, and press on the “Done” button to change to that company, or press on “Cancel” to stay working with the same company. The user may also select the Screen they would like to have displayed for them upon Login by pressing in the “Home Page” field, which will display a slide-up screen with a list of valid Home Pages to choose from. They may then select the Home Page they wish to see upon Login, and then press on the “Done” button to save their change, or press on “Cancel” to keep the same Home page. The User may check their Online or Offline status (connected to the cloud) by viewing the Online/Offline indicator. If they are connected to the cloud (Online), the “Online” indicator will be blue. If they are not connected to the cloud (Offline), the “Offline” indicator will be blue. They may change their connected status by pressing on the indicator that is not currently blue. If they are “Offline” and press on the “Online” indicator, it will only change connected status if a connection to the internet is available on their mobile device. The user may keep the “Auto-sync” from happening unless they are connected via a Wi-Fi connection by pressing the check mark to the right of the “AutoSync on Wi-Fi Only” field. If the check mark is blue this feature is selected. If grey, the application will attempt to sync with the cloud so long as it is connected to the Internet. If the user is an Administrator, they may see Events, Sessions, and Media to which they have not specifically been given access by selecting the check mark to the right of the “Show all Users” field. If the check mark is blue, they will be able to see all Events, Sessions, and Media within their company. If the check mark is grey, they only see Events, Sessions, and Media to which they have been given explicit access (added as a Member, Participant, or Group). If the user has been ‘Offline’ using the application, and they are now connected to a network, they may use the “Manual Sync” button to force the application to synchronize their data with the cloud. The application will indicate with a counter the number of items that have not yet been synchronized just above the “Manual Sync” button. If this number is 0 (zero), no synchronization is necessary. By pressing the “Troubleshooting” button, a user is shown a screen that contains several pieces of information about both the User's device, as well as the status of the application. Additionally, they may run speed tests to determine the quality of their network connection, view the crash log, and send a diagnostic log via email to any email address. To run one or more speed tests on their network connection, they first select which test (or tests) they would like to run. They do this by pressing on the check mark next to one or more of the indicated speed tests (“Upload Test to vMobile”, “Download Test from vMobile”, “Network Bandwidth Test”). Once they have selected at least one test, they may press on the “Run Test” button in the lower left-hand corner of the screen. This will run the desired tests and show the results on the results screen. Pressing the “Close” button will return them to the Troubleshooting screen. If, for some reason, the application has an issue, the user may see a log of the crashes of the vMobile Collaborator application by pressing on the “Crashes” button in the bottom middle of the screen. A new page showing a description of the crash, along with the date and time of its occurrence will display. To close the page, the user may press on the “X” button in the upper right-hand corner, and they will be taken back to the Troubleshooting page.

If the user would like to email a log of all of the activity performed while using the application, they may press on the “Email Log” button in the bottom right-hand corner of the screen, and the email client on their mobile device will be accessed, allowing them to email the log to any email address. Once the email is sent, they will be returned to the Troubleshooting screen.

### Search Icon

If the user needs to search for something in the application, they may select the Search icon, which will display the Search screen for them. At that point they may select which content within the application will be searched for their search string, either choosing “All”, which will search all content (Events, Sessions, Media), or any combination of the individual content. Then they may choose which fields within the content will be searched, either “All” fields, or any combination (Tags, Title, Description, Date/Time, and Address). Once the areas and fields are selected and a string is entered into the search field the application will do a contextual search for any content containing the search string in any of the fields selected.

### Dashboard

The User may access their personalized dashboard by pressing on the Dashboard icon on the vMCC screen, which displays the User's specific combination of information which is most important to them (as defined by each User in the Profile section of the Web application).

vMIC (vMobile Instant Communicator)

By using the vMIC (vMobile Instant Communicator) function within the application, and accessible from the vMCC menu, the User may notify other Users that they are available for Instant Communications, or initiate an Instant Communicator session with one or more other Users who have indicated that they are available. To indicate that a User is available for Instant Communications, the User presses on the Available button within the vMIC screen, which is then viewable to all other Users within their company. If a User logs off of the application, or removes the application from their mobile device's memory, they instantly become unavailable. If a User is in the Available mode, and another User attempts to use the Instant Communicator with them, a tone sounds on their mobile device, and a Push notification appears. Pressing on the Push notification takes them to the vMIC screen (requiring them to re-login, if they have exceeded the timeout period), and they are presented with an option to accept or reject the Instant Communication. If they accept, a TALK button appears, which activates the microphone on their device to talk to the other party or parties in the Instant Communicator session. When they stop pressing the button, they are in listen mode, and they can hear other parties in the session when they are talking At any time, the User may remove themselves from the Instant Communicator session by pressing on the Disconnect button. If a User would like to initiate an Instant Communicator session, they press on the Instant Communicator button, and a list of available Users is presented to them. At this time, they select the User or Users that they would like to communicate with from the list, and press the Initiate button to start the Instant Communicator session. Once the first User on the list of selected Users accepts the invitation, the Instant Communicator session begins. When only one User is left in the session, the session ends.

### Combined Mobile/Web Application Use

In one embodiment of the use of the application, multiple Users of the system, one on the Mobile application and the other on the Web Application, use the two applications in the following manner.

### Event/Session Setup

A User of the Web Application, typically in an office environment, creates a new Event, either because of a call from a customer describing a problem or issue at a location (possibly also using the Mobile Application to capture Media about the problem or issue), and may create one or more Sessions associated with the Event. The Web Application user adds the Mobile User as a Member of the Event and Session, as well as adds several Tags to each of the Events/Sessions.

### Field Use

When the field technician (or worker) reaches the location of the Event in the field, they access the Mobile Application, and can access the Event and Sessions (as well as any Media added during setup). The Mobile User then adds additional Media, Tags, and Notes during their time in the field, creating a rich collection of information captured from both internal and external sources.

### Live Collaboration

While in the field, the Mobile User may initiate a Live Stream (or it may be initiated by the Web User in the office) to share live activity that is happening at their location (machine operation, weather conditions, sports event, etc.) with the Web Application User, or any number of both Web Application Users and/or Mobile Application Users. During the Live Stream any Participant may capture the Stream to the cloud or capture an image from the Live Stream. At any time, any Participant may add Media, Notes, or Tags, and they are instantly saved to the cloud, and available to any other Participant for viewing.

### Inviting Another User or Guest to a Session

As described within the Event/Session List description and specifically in Edit Session Participants section, a user or a guest can be invited to join a Session. When the user selects to send an invitation they are prompted, where appropriate, whether they would like to send the link by SMS/Messaging or email. Once selected, the User is presented a screen wherein they must enter the phone number or email. The subject (if appropriate) and body of the message is automatically filled out with a message describing the invitation and also includes a unique link that can be clicked on that automatically takes that invited user/guest directly into the Session to which they have been invited. In the case that the User is on a mobile device, and has not downloaded the vMobile Collaborator application, they are prompted with a link that can be clicked to access the download on the App Store prior to using the link to take them to the Session to which they have been invited.

The unique link has a limited lifespan and may be configured during server administration. Links may also expire after they are clicked on once, if configured this way by a customer's Administrator User.

With respect to the overall architecture, and specifically describing the architecture described in the Figures, the system is designed in an n-tier architecture that can be scaled both vertically and horizontally, which allows for growth in both functionality (vertically) and size (horizontally). There are four layers of architecture that make up the technical architecture. These are: User, Presentation, Application, and Database. Each layer leverages SSL and 512-bit encryption to securely deliver content, and protect sensitive data.

User: This layer is supplied by the users of our system, and are comprised of the physical hardware (laptop, desktop, netbook, mobile device, etc.), the underlying operating system, and a web browser (i.e., FireFox, Safari, Chrome, etc.).

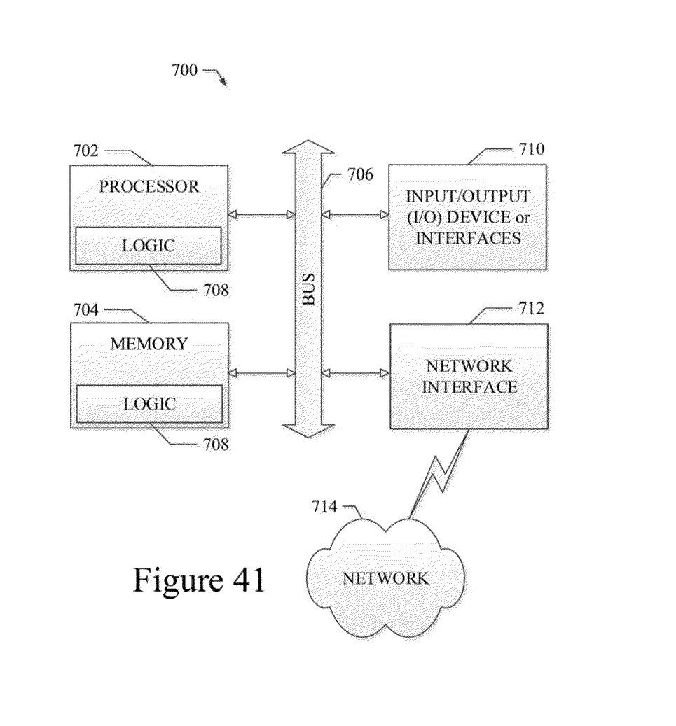

FIG. 41 shows a diagrammatic representation of a machine in the example form of a stationary or mobile computing and/or communication system 700 within which a set of instructions when executed and/or processing logic when activated may cause the machine to perform any one or more of the methodologies described and/or claimed herein. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example stationary or mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The stationary or mobile computing and/or communication system 700 may further include various input/output (I/O) devices and/or interfaces 710, such as a monitor, touchscreen display, keyboard or keypad, cursor control device, voice interface, and optionally a network interface 712. In an example embodiment, the network interface 712 can include one or more network interface devices or radio transceivers configured for compatibility with any one or more standard wired network data communication protocols, wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth, IEEE 802.11x, and the like. In essence, network interface 712 may include or support virtually any wired and/or wireless communication mechanisms by which information may travel between the stationary or mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the stationary or mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a mobile device having a mobile data processor and a mobile application executable by the mobile data processor;
a web-based computing system having a web data processor and a web application executable by the web data processor, the mobile application and the web application being in data communication via a data network;
a data repository in data communication with the mobile application and the web application;
the mobile application and the web application being configured to operate collaboratively to: collect digital media for storage in the data repository, the digital media being of any type from the group consisting of: images, video, audio, and documents;
the mobile application and the web application being configured to catalog the digital media using metadata including tags and notes, the cataloging including automatically tagging digital media with an associated date, time, user, and geographical location; and
the mobile application and the web application being configured to associate the digital media with corresponding events and sessions and enable access to the digital media by an owner or contributor of a corresponding event or session.

2. The system of claim 1 further comprising a backend processes to organize and store the collected content, metadata, and data in such a way as to make it retrievable and available in a manner that is accessible both while a user of the application is either online or offline.

3. The system of claim 1 wherein the mobile application and the web application being configured to create an event having a plurality of associated sessions.

4. The system of claim 1 wherein the mobile application being configured to create a session having a plurality of associated participants.

5. The system of claim 1 wherein the mobile application being configured to create a session having a plurality of associated participants, the mobile application being further configured to initiate a live video stream, which can be shared among the plurality of associated participants of the session.

6. The system of claim 1 wherein the mobile application being configured to generate an electronic invitation to grant access for a participant to content associated with an event or a session.

7. The system of claim 1 wherein the mobile application being configured to enable an invited participant to view a list of events or sessions.

8. The system of claim 1 wherein the mobile application being configured to enable an invited participant to view, modify, or add content associated with an event or a session.

9. The system of claim 1 wherein the mobile application being configured to enable a participant to add a tag to an associated event or session.

10. The system of claim 1 being configured to enable a user to upload media content and associate the media content with an event or a session.
